(19) United States
(12) Patent Application Publication
(10) Pub. No.: US 2025/0095307 A1
(43) Pub. Date: Mar. 20, 2025

(54) VIDEO-SEE-THROUGH (VST) DEVICE FOR INTERACTING WITH OBJECTS WITHIN A VST ENVIRONMENT AND METHOD FOR OPERATING THE SAME

(71) Applicant: SAMSUNG ELECTRONICS CO., LTD., Suwon-si (KR)

(72) Inventors: Biju Mathew NEYYAN, Bangalore (IN); Vivek SRIDHAR, Bangalore (IN); Arshed V. HAKEEM, Bangalore (IN); Shubhankar BHINGARE, Bangalore (IN)

(73) Assignee: SAMSUNG ELECTRONICS CO., LTD., Suwon-si (KR)

(21) Appl. No.: 18/967,138

(22) Filed: Dec. 3, 2024

Related U.S. Application Data
(63) Continuation of application No. PCT/KR2024/095983, filed on Aug. 2, 2024.

(30) Foreign Application Priority Data
Aug. 2, 2023 (IN) 202341052063
Jul. 15, 2024 (IN) 202341052063

(51) Int. Cl. G06T 19/00; G06F 3/01; G06T 19/20; G06V 10/25

(52) U.S. Cl. CPC G06T 19/006; G06F 3/013; G06F 3/017; G06T 19/20; G06V 10/25; G06T 2219/2016; G06V 2201/07

(57) ABSTRACT

Provided are video-see-through (VST) device for interacting with a spatial object and an operating method the VST device. The VST device receives a user gesture of a user, wherein the user gesture is for selecting a spatial region of interest (ROI) within a field of view of the user; recognizes the spatial ROI and an object located within the selected spatial ROI; generates a virtual bounding region enclosing the recognized object located within the selected spatial ROI; determines an associated modality for enabling an interaction with the object located within the generated virtual bounding region; and generates a prompt corresponding to the associated modality.

### CROSS REFERENCE TO RELATED APPLICATIONS

This application is a by-pass continuation application of International Application No. PCT/KR2024/095983, filed on Aug. 2, 2024, which is based on and claims priority to Indian Patent Provisional Application No. 202341052063, filed on Aug. 2, 2023, and Indian patent application No. 202341052063, filed on Jul. 15, 2024, in the Indian Intellectual Property Office, the disclosures of which are incorporated by reference herein their entireties.

### BACKGROUND

### 1. Field

The disclosure relates to ‘video-see-through’ (VST) and optical see-through visualization technologies, and more particularly, but not exclusively to systems and methods for enabling multimodal spatial interaction through a VST device and generating one or more associated functions and responses corresponding to the multimodal interaction within a VST environment.

### 2. Description of Related Art

In general, the real world may be combined with a virtual world using computer implemented technologies to support a user interacting with real life objects or virtual objects placed in a real world, in real time within the virtual world. A real world is overlaid with computer generated virtual information for facilitating natural communication between the user and a plurality of Augmented Reality (AR) and Virtual Reality (VR) systems using multiple modes of spatial interaction.

However, for multimodal spatial interactions, there exists no consistent way to select two dimensional (2D) region or three dimensional (3D) volume across a device or a platform and perform further actions via other modalities such as voice commands. Further, there exists no way to select multiple objects that might be occluding each other in a spatial environment.

Hence, there is a need in the art for solutions which will overcome the above mentioned drawbacks.

### SUMMARY

Provided are methods and systems for enabling multimodal spatial interaction through a video see through (VST) device.

Provided are methods and systems for marking spatial-temporal regions within a VST environment and enabling one or more associated functions and responses within the spatial-temporal regions.

Provided are methods and systems for receiving and identifying a plurality of user gestures for marking spatial-temporal regions within a VST environment.

Provided are methods and systems for selecting at least one object in a physical world, wherein the at least one selected object is located within a spatial-temporal regions, which has been marked using the one or more user gestures.

Provided are methods and systems for interacting with an object detected by a user of the VST device in a virtual mode.

Provided are methods and systems for selecting multiple objects using a plurality of user gestures by considering a physical environment and dimensions of the multiple objects.

Provided are methods and systems for selecting multiple objects using a plurality of user gestures by considering a physical environment and dimensions of the multiple objects, wherein the multiple objects may be occluded.

Provided are methods and systems for determining context of a marked region in a virtual environment by analyzing a type of region-of-interest (RoI) (2D or 3D), and understanding content present inside a marked spatial-temporal region and corresponding relevant contents outside the bounding box.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

According to an aspect of the disclosure, a method operated by a video-see-through (VST) device, comprises: receiving at least one user gesture of a user for selecting a spatial region of interest (ROI) within a field of view of the user; recognizing the spatial ROI and at least one object located within the selected spatial ROI; generating at least one virtual bounding region enclosing the at least one recognized object located within the selected spatial ROI; determining at least one associated modality for enabling an interaction with the at least one object located within the at least one virtual bounding region; and generating at least one prompt corresponding to at least one associated modality for interaction with the at least one object. The at least one prompt for a user interaction within the field of view of the user is generated based on a relative position of a hand of the user and the spatial ROI.

According to an aspect of the disclosure, a method operated by a video-see-through (VST) device for enabling gesture based object interactions, comprises: receiving a user gesture indicative of a selection of a region of interest within a field of view during at least one of an immersive mode and an Augmented reality (AR) mode of the VST device; recognizing a three dimensional space and one or more objects including an application, an appliance, a real object and a virtual object within the three dimensional space of the VST device; scaling a boundary of the region of interest relative to the three dimensional space and the gesture to generate the region of interest in the field of view of the user; determining one or more objects in the region of interest and an associated modality for interaction with each object; generating a prompt associated with the at least one associated modality for interaction with each object, and providing the prompt for a user interaction within the field of view of the user based a relative position of a user hand and the region of interest.

According to an aspect of the disclosure, a video-see-through (VST) device comprises: an user input interface configured to receive gesture input from a user; at least one memory storing one or more instructions; at least one processor operatively connected to the at least one memory and configured to execute the one or more instructions to cause the VST device to: receive, through the user input interface, at least one user gesture of the user for selecting a spatial region of interest (ROI) within a field of view of the user; recognize the spatial ROI and at least one object located within the selected spatial ROI; generate at least one virtual bounding region enclosing the at least one recognized object located within the selected spatial ROI;

determine at least one associated modality for enabling an interaction with the at least one object located within the at least one virtual bounding region; and generate at least one prompt corresponding to the at least one associated modality for interaction with the at least one object, based on a relative position of a hand of the user and the spatial ROI.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

Embodiments herein are illustrated in the accompanying drawings, throughout which like reference letters indicate corresponding parts in the various figures. The embodiments herein will be better understood from the following description with reference to the following drawings. Embodiments herein are illustrated by way of examples in the accompanying drawings, and in which:

FIG. 1 is a block diagram illustrating various components of a proposed VST device, according to embodiments as disclosed herein;

FIG. 2 is a block diagram illustrating subcomponents of the various components of the proposed VST device, according to embodiments as disclosed herein;

FIG. 3A is a flowchart for recognizing a compound space-time region of interest (ROI) marking gesture used for obtaining the final ROI bounding region, according to embodiments as disclosed herein;

FIG. 3B is a flowchart for recognizing a compound space-time region of interest (ROI) marking gesture used for obtaining the final ROI bounding region, according to embodiments as disclosed herein;

FIG. 3C is a flowchart for recognizing a compound space-time region of interest (ROI) marking gesture used for obtaining the final ROI bounding region, according to embodiments as disclosed herein;

FIG. 4A is a flowchart illustrating a method for enabling gesture-based object interactions in the VST device, according to embodiments as disclosed herein;

FIG. 4B is a flowchart illustrating a method for enabling gesture-based object interactions in the VST device, according to embodiments as disclosed herein;

FIG. 5A is a view illustrating a method for generating spatial-temporal ROI using a plurality of user hand gestures according to embodiments as disclosed herein;

FIG. 5B is a view illustrating a method for generating spatial-temporal ROI using at least one user hand gesture according to embodiments as disclosed herein;

FIG. 5C is a view illustrating a method for generating spatial-temporal ROI using a plurality of user hand gestures and an eye gaze according to embodiments as disclosed herein;

FIG. 5D is a view illustrating a method for generating spatial-temporal ROI using a plurality of user hand gestures and an eye gaze according to embodiments as disclosed herein;

FIG. 5E is a view illustrating a method for generating spatial-temporal ROI using a plurality of user hand gestures and a head gaze according to embodiments as disclosed herein;

FIG. 5F is a view illustrating a method for generating spatial-temporal ROI using a plurality of user hand gestures and a head gaze according to embodiments as disclosed herein;

FIG. 5G is a view illustrating a method for generating spatial-temporal ROI using a plurality of user hand gestures, an eye gaze, and a head gaze according to embodiments as disclosed herein;

FIG. 5H is a view illustrating a method for generating spatial-temporal ROI using a plurality of user hand gestures, an eye gaze, and a head gaze according to embodiments as disclosed herein; and

FIG. 6 depicts example use cases of a proposed VST device, according to embodiments as disclosed herein;

FIG. 7 depicts example use cases of a proposed VST device, according to embodiments as disclosed herein;

FIG. 8 depicts example use cases of a proposed VST device, according to embodiments as disclosed herein;

FIG. 9 depicts example use cases of a proposed VST device, according to embodiments as disclosed herein; and

FIG. 10 depicts example use cases of a proposed VST device, according to embodiments as disclosed herein;

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments. Further, in the present disclosure the terms “real world”, “physical environment”, “physical surroundings” and “Physical world” are used interchangeably. Furthermore, in the present disclosure the terms “virtual world”, and “virtual environment” are used interchangeably.

The term “couple” and the derivatives thereof refer to any direct or indirect communication between two or more elements, whether or not those elements are in physical contact with each other. The terms “transmit”, “receive”, and “communicate” as well as the derivatives thereof encompass both direct and indirect communication. The terms “include” and “comprise”, and the derivatives thereof refer to inclusion without limitation. The term “or” is an inclusive term meaning “and/or”. The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” refers to any device, system, or part thereof that controls at least one operation. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C, and any variations thereof. As an additional example, the expression “at least one of a, b, or c” may indicate only a, only b, only c, both a and b, both a and c, both b and c, all of a, b, and c, or variations thereof. Similarly, the term “set” means one or more. Accordingly, the set of items may be a single item or a collection of two or more items.

Embodiments herein may be described and illustrated in terms of blocks which carry out a described function or functions. These blocks, which may be referred to herein as a head gaze tracker, an eye gaze tracker, a visual analyzer, a scene analyzer, a content analyzer, a gesture recognizer, an ROI generator, an action executor, a VST mode identifier, an artificial intelligence (AI) recommender engine, a command recommender, a modality recommender, an interaction generator, a boundary generator engine, a transformation computation engine, an ROI computation engine, content capturing code, multimodal fusion code, or the like, are physically implemented by analog and/or digital circuits such as logic gates, integrated circuits, microprocessors, microcontrollers, memory circuits, passive electronic components, active electronic components, optical components, hardwired circuits, and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which include the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

While the disclosure is susceptible to various modifications and alternative forms, specific embodiment thereof has been shown by way of example in the drawings and will be described in detail below. It should be understood, however that it is not intended to limit the disclosure to the specific forms disclosed, but on the contrary, the disclosure is to cover all modifications, equivalents, and alternative falling within the scope of the disclosure.

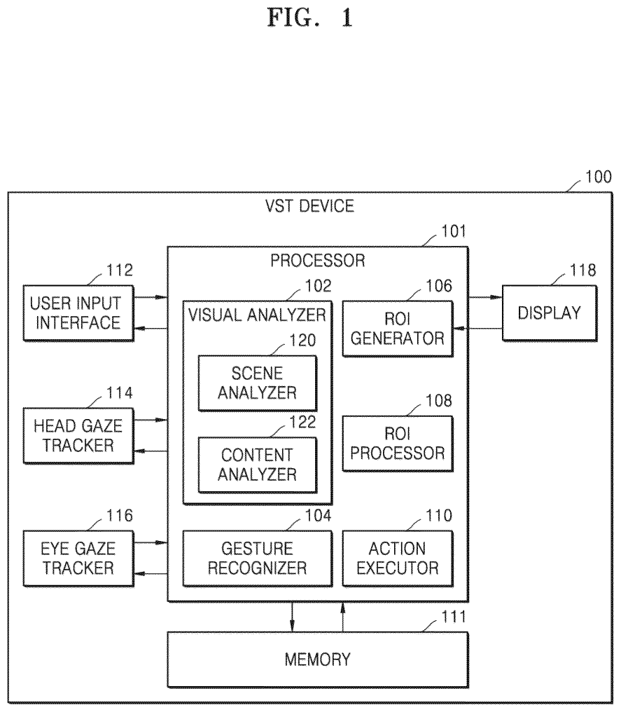

The embodiments herein achieve system(s) and method(s) for facilitating a spatial-temporal marking to interact with at least a real world object and at least one virtual object placed around a user. Referring now to the drawings, and more particularly to FIGS. 1 through 8, where similar reference characters denote corresponding features consistently throughout the figures, there are shown embodiments.

FIG. 1 is the block diagram illustrating various components of the proposed VST device 100, according to one or more embodiments as disclosed herein. The VST device comprises a processor 101, an user input interface 112, a head gaze tracker 114, an eye gaze tracker 116, a memory 111, a display 118, and a communication circuit.

The processor 101 may include various processing circuitry and execute a program code or one or more instructions stored in the memory 111. The processor 101 may include one or a plurality of processors. The one or the plurality of processors may be a general-purpose processor, such as a central processing unit (CPU), an application processor (AP), or the like, a graphics-only processor such as a graphics processing unit (GPU), a visual processing unit (VPU), and/or an AI-dedicated processor such as a neural processing unit (NPU). The processor 101 may include multiple cores and is configured to execute the instructions stored in a memory 111.

The processor 101 according to one or more embodiments of the disclosure may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the processor 101 may include a combination of processors performing various of the recited/disclosed functions, e.g., in a distributed manner. The processor 101 may execute program instructions stored in the at least one memory 111 to achieve or perform various functions.

In one or more embodiments depicted in FIG. 1, the processor 101 may include a visual analyzer 102, a gesture recognizer 104, an ROI generator 106, an ROI processor 108, and an action executor 110. The visual analyzer 102, the gesture recognizer 104, the ROI generator 106, the ROI processor 108, and the action executor 110, individually and/or collectively in a distributed manner, may be configured to perform various functions described herein.

The memory 111 may store one or more instructions to be executed by the processor 101. The memory 111 may include one or more non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the at least one memory 111 may, in some examples, be considered a non-transitory storage medium. The term “non-transitory” may indicate that the storage medium is not embodied in a carrier wave or a propagated signal. However, the term “non-transitory” should not be interpreted that the memory 111 is non-movable. In certain examples, a non-transitory storage medium may store data that may, over time, change (e.g., in Random Access Memory (RAM) or cache). The visual analyzer 102 may receive ‘video-see-through’ (VST) information from the VST device 100 and may identify at least one mode of visualization as viewed by a user of the VST device. Examples of the at least one mode of visualization may be at least one of an immersive mode of vision and an augmented mode of vision. Further, the visual analyzer 102 may include a scene analyzer 120 for analyzing a physical environment as viewed through the VST device 100. The visual analyzer 102 may further include a content analyzer 122 for analyzing device content as viewed through the VST device 100. In an example embodiment, if the visual analyzer 102 identifies the mode of visualization as an immersive mode of visualization, the visual analyzer 102 may analyze the device content viewed through the VST device 100. Further, with respect to another example embodiment, if the visual analyzer 102 identifies the mode of visualization as an augmented mode of vision, the visual analyzer 102 may analyze the physical environment as viewed through the VST device 100. In an example embodiment, the at least one object present in the physical environment may include at least one of at least one 2D object, and at least one 3D object. With respect to one or more embodiments herein, the VST device 100 may detect head orientation and eye gaze of the user (who is currently using the VST device 100) through the VST device 100. In an example embodiment, the VST device 100 may include a head gaze tracker 114 for detecting the head orientation of the user and an eye gaze tracker 116 for detecting the eye gaze of the user.

The gesture recognizer 104 may receive a plurality of user-gestures of the user of the VST device 100 through a user input interface 112. In an example embodiment, the plurality of user gestures is a plurality of hand gestures performed by the user. The plurality of hand gestures as received by the gesture recognizer 104 may be recognized for differentiating distinct gestures thereby enabling the user to mark at least one spatial-temporal region within a VST environment, wherein the VST environment is created by the VST device.

The ROI generator 106 may receive a plurality of recognized user gestures from the gesture recognizer 104 and at least one analysis output from the visual analyzer 102. The ROI generator 106 may further generate a virtual bounding region within the field of view of the user. In an example embodiment, the virtual bounding region is generated for at least one object located in a physical environment. In an embodiment, the virtual bounding region may be generated by the ROI generator 106 in a virtual environment of vision as viewed by the user for an immersive mode of vision of the VST device, wherein the virtual bounding region may fit at least one object of the virtual environment of vision within the virtual bounding region.

The ROI generator 106 may scale the virtual boundary region based on the plurality of user gestures recognized by the gesture recognizer 104. In an example embodiment, the ROI generator 106 may scale a size of the virtual bounding region based on relative positions of hands of the user changed by the plurality of user gestures.

The ROI processor 108 may be an ROI processor. The ROI processor 108 may receive output from the ROI generator 106 and analyze the output in order to detect a type of the at least one object. The at least one object may be at least one of at least an object of the physical environment of vision and at least an object of the virtual environment of vision. In an example embodiment, the type of the at least one object may be, without limitation, an object with textual body, an object with audio, an object with video and so on. On detecting the type of the at least one object, the ROI processor may prompt the user to input at least one user command through at least one input-command modality, for interacting with the at least object within the ROI. In an embodiment, the at least one input-command modality may be displayed on the display 118. Examples of the at least one input-command modality may be, but not limited to, at least a voice modality, at least a touch-based modality and so on. The at least one input-command modality may enable the user to carry out quicker interaction(s) with the at least one object within the ROI.

The action executor 110 may interpret the at least one user command and the at least one object within the ROI, in order to generate at least one action related to the at least one object, based on the at least one user command.

The display 118 is configured to display the virtual bounding region generated by the ROI generator 106. Further, the display 118 is configured to display at least one prompt for a user interaction with the at least one object within the virtual bounding region. The display 118 of the VST device 100 may be implemented by, for example, at least one of a liquid-crystal display (LCD), a thin-film-transistor liquid-crystal display (TFT-LCD), an organic light-emitting diode (OLED) display, a flexible display, a three-dimensional (3D) display, or an electrophoretic display.

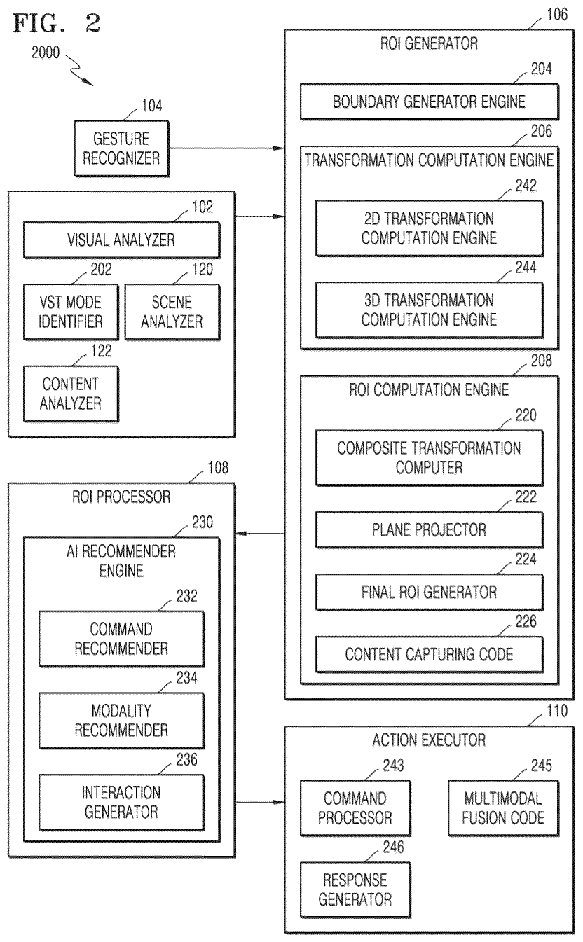

However, the disclosure is not limited thereto. In a case in which the VST device 100 is implemented as augmented reality glasses, the display 118 may be configured as a lens optical system and may include a waveguide and an optical engine. The optical engine may include a projector configured to generate light of a three-dimensional virtual object configured as a virtual image, and project the light to the waveguide. The optical engine may include, for example, an image panel imaging panel, an illumination optical system, a projection optical system, and the like. In an embodiment of the disclosure, the optical engine may be arranged in the frame or temples of the augmented reality glasses. In an embodiment of the disclosure, the optical engine may display the virtual bounding region or the at least one prompt by projecting, to the waveguide, light of the virtual bounding region or the at least one prompt for providing an image to the user, under control of the processor 101. FIG. 2 is a block diagram depicting subcomponents of the various components of the proposed VST device, according to one or more embodiments as disclosed herein. In an embodiment, the visual analyzer 102 comprises at least one VST mode identifier 202, at least one scene analyzer 120, and at least one content analyzer 122. The VST mode identifier 202 may determine a mode of visualization of the user viewing through the VST device 100. In an example embodiment, the mode of visualization may be at least one of an Augmented Reality (AR) mode of vision and an immersive mode of vision.

In AR mode of vision as detected by the VST mode identifier 202, the scene analyzer 120 is triggered by the ROI processor 108, wherein the scene analyzer 120 may analyze a physical environment that the user is currently viewing. In an embodiment, the scene analyzer 120 of the visual analyzer 102, may perform surface mapping in order to map different features of a physical surrounding of the user. Further, the scene analyzer 120 may perform dimension estimation of the physical surroundings from the surface mapping. The dimension estimation may include estimation of rotation, translation and scaling factor for user's gesture input. Further, the scene analyzer may perform scene segmentation of the physical surrounding of the user. In an embodiment, the physical surrounding of the user includes at least one physical object in space as viewed through the VST device 100. Further, in an embodiment, a gesture recognizer 104 of the VST device 100 may receive a plurality of user gestures and carry out identification of distinct gestures of the user.

In an immersive mode of vision as detected by the VST mode identifier 202, the content analyzer 122 is triggered by the ROI processor 108, wherein the content analyzer 122 may analyze a virtual surrounding of the user. In an embodiment, the content analyzer 122 may perform device content type identification by mapping different features of user's virtual surrounding. The VST device may map different features of the user's virtual surrounding to estimate a rotation, a translation and a scaling factor of the plurality of user gestures. Further, the content analyzer 122 may perform scene segmentation of the user's virtual surroundings.

In an embodiment, the ROI generator 106 may include at least one boundary generator engine 204, at least one transformation computation engine 206, and at least one ROI computation engine 208. The at least one boundary generator engine 204 may receive the plurality of user gestures from the gesture recognizer 104 and may perform spatial-temporal marking within the VST environment. The boundary generator engine 204 may generate the spatial-temporal marking within the VST environment by generating an initial spatial ROI boundary based on a plurality of initial spatial ROI marking points, wherein the at least one initial spatial ROI boundary may be at least one of a 2D initial spatial ROI boundary and a 3D initial spatial ROI boundary. In an embodiment, the plurality of initial spatial ROI marking points is received from the gesture recognizer 104, wherein the gesture recognizer 104 is configured to identify distinct gestures being performed by the user. In an example embodiment, the plurality of initial spatial marking points may be obtained from the plurality of hand gestures of the user, wherein the plurality of initial spatial marking points is generating an initial spatial ROI boundary in at least one of a 2D and a 3D. In an embodiment, for obtaining an initial spatial-temporal ROI boundary, the boundary generator engine 204 may generate an initial temporal ROI boundary from the initial spatial ROI boundary. The boundary generator engine 204 may correlate the initial spatial ROI boundary with a plurality of temporal markers, for obtaining the initial spatial-temporal ROI boundary. In an embodiment, the plurality of temporal markers is the time corresponding to which the plurality of hand gestures is held. In an example embodiment, the plurality of initial spatial marking points further may be obtained using a plurality of hand gestures of the user, and at least one of an eye gaze and a head gaze.

The transformation computation engine 206 may include at least one 2D transformation computation engine 242 and at least one 3D transformation computation engine 244. In an embodiment, the at least one 2D transformation computation engine 244 may compute translational transformation (position) and scaling transformation (size) of the initial spatial-temporal ROI boundary generated by the boundary generator engine 204, in order to obtain a plurality of transferal marking points from the plurality of user gestures. In an example embodiment, the plurality of transferal marking points further may be obtained using a plurality of hand gestures of the user, and at least one of an eye gaze and a head gaze. Further, in an embodiment, the at least one 3D transformation computation engine 244 may compute a rotational transformation (orientation/angle) of the initial spatial-temporal ROI boundary based on head orientation of the user. The rotational transformation (orientation/angle) may be used to obtain a plurality of transferal marking points, for the initial spatial-temporal ROI boundary. In an embodiment, for a mode of visualization such as an AR mode of vision, the plurality of transferal marking points is obtained, from one or more visual-inputs, as received from the visual analyzer 102, in the AR mode. In an example embodiment, the one or more visual inputs in the AR mode comprises, dimension of user's physical surroundings, surface in the user's field of view, position of one or more physical objects in the field of view of the user, and at least one selected physical object located within the initial ROI boundary. Further, with respect to another embodiment, for a mode of visualization (such as an immersive mode of vision), the plurality of transferal marking points is obtained, from one or more visual-inputs, in the immersive mode. In an example embodiment, the one or more visual-inputs in the immersive mode comprises dimension of the user's virtual surroundings, at least one of a 2D and a 3D nature of content the user is viewing through the VST device.

The ROI computation engine 208 may include at least one composite transformation computer 220, at least one plane projector 222, at least one final ROI generator 224, and at least one content capturing code 226. Based on received inputs from the transformation computation engine 206, the composite transformation computer 220 may compute a final composite transformation for the at least one initial spatial-temporal ROI boundary. The composite transformation computer 220 may further understand a 2D and/or a 3D nature of the plurality of user gestures for computing the final composite transformation to the initial spatial-temporal ROI boundary. The composite transformation computer 220 further may apply the computed final composite transformation, to the at least one initial spatial-temporal ROI boundary to obtain a transformed candidate ROI boundary. The plane projector 222 may project the transformed candidate ROI boundary onto at least one of the physical surrounding of the user, if the mode of visualization is an AR mode. The plane projector 222 may project the transformed candidate ROI boundary onto the virtual surrounding of the user if the mode of visualization is an immersive mode. The plane projector 222 may further compute projection details for the transformed candidate ROI boundary for obtaining a transformed spatial-temporal boundary. In an embodiment, the projection details for obtaining at least one transformed spatial boundary are computed, based on surfaces in space of the at least one of the physical surrounding of the user and the virtual surrounding of the user. The final ROI generator 224 may generate a final spatial-temporal ROI bounding region (hereinafter referred as final ROI bounding region) from the initial spatial-temporal ROI boundary and the at least one transformed spatial boundary. In an embodiment, the final ROI generator 224 may generate a final spatial-temporal ROI bounding region by scaling the at least one spatial boundary based on the plurality of user gestures. In an example embodiment, the final ROI generator 224 may scale the at least one spatial boundary based on relative positions of hands of the user changed by the plurality of user gestures. In an embodiment, the final ROI bounding region may take any suitable shape in at least one of a 2D field of view and a 3D field of view of the user, wherein the suitable shape may be such as a rectangle, a circle and so on in a 2D field of view. The content capturing code 226 may be configured to initiate capturing of one or more contents present within the final ROI bounding region. In an example embodiment, the one or more contents present within the final ROI bounding region may be at least one of one or more objects located in the AR mode of vision of the user and one or more objects located in an immersive mode of vision of the user. In an embodiment, the one or more contents present within the final ROI bounding region may be used for further processing of the final ROI bounding region in selecting multiple objects within the field of view of the user. With respect to one or more embodiments herein, one or more objects located within the final ROI bounding region may be at least one of one or more objects with one or more textual elements, one or more objects with one or more audio elements, one or more objects with one or more video elements, and so on. Output from the ROI recognizer may be transferred to the ROI processor 108.

In an embodiment, the ROI processor 108 may recognize one or more visual elements in the final ROI bounding region, wherein recognition of one or more visual elements may be object recognition, textual element recognition, audio element recognition, video element recognition and so on.

In an embodiment, the ROI processor 108 may include at least one AI recommender engine 230. The at least one AI recommender engine 230 may prompt the user to input at least one user command via at least one input-command modality, for interacting with at least one object selected from the one or more objects present within the final ROI bounding region. Further, in an embodiment, the AI recommender engine 230 may include a command recommender 232, a modality recommender 234 and an interaction generator 236.

Based on the nature of the at least one object selected within the final ROI bounding region, the command recommender 232 may determine the at least one user command. The at least one user command may be an input to the ROI processor 108. The command recommender 232 further may fetch external information regarding the at least one object selected within the final ROI bounding region. Examples of the external information may be such as, but not limited to, device capabilities and so on. The external information regarding the at least one object selected within the final ROI bounding region are fetched, and the fetched external information may be used for determining the at least one user command with suitable modality for interacting with the at least one object located within the final ROI bounding region. The command recommender 232 may further determine probability of each of the user command resulting in ROI processing results based on the prominence of each different type of input user command and the general frequency of use of a particular functionality. The command recommender 232 may associate a confidence or likelihood score with each user command.

The modality recommender 234 may recommend a suitable modality to the user to the input user command to the ROI processor 108. Based on ease-of-use of each modality for a particular command, the modality recommender 234 may determine one or more input-command modalities for the top ‘n’ user commands. In an example embodiment, ease-of-use of a modality for a particular command may be such as, search is easy with voice and selection is easier by touch, and so on. For identification of a recommended modality per command, the modality recommender 234 may consider multiple additional parameters such as the ability to perform for multiple user commands with a single modality and a relative likelihood between multiple top recommended commands.

The interaction generator 236 of the AI recommender may generate at least one prompt for enabling a user of the VST device to interact with at least one selected object within the VST environment. In an embodiment, the generated at least one prompt may be dynamically adjusted in position by the VST device 100 based on real-time input from the user and changes its position in the VST environment taking into account both the user's movement, position and hand reach. In an example embodiment, based on a user command fed to the ROI processor 108 and at least an output from the modality recommender 234, the interaction generator may generate a voice prompt. The voice prompt may be one of a specific voice prompt for a top user command (if highly likely) or a generic voice prompt which allows the user to perform multiple top user commands. Further, with respect to an example embodiment, the interaction generator 236 may provide one or more visual prompts for the user command where touch or gesture is the preferred modality to input the user command in the VST device 100.

In an embodiment, to provide one or more visual prompts for the user command, the interaction generator may perform position tracking and hand reach assessment. The interaction generator 236 may track at least an orientation of hand, at least a position of hand, at least a head gaze of the user and at least an eye gaze of the user. The visual analyzer 102 may continuously monitor the position of the user's hand movement relative to the initial ROI boundary and may transfer information on the position of the user's hand movement to the ROI processor 108. The interaction generator 236 may further generate one or more visual prompts tailored to the user's capabilities, based on the output from the position tracking and hand reach assessment. Further, the interaction generator 236 may adjust placement and size of the one or more visual prompts. Further, the interaction generator may render the one or more visual prompts and display the rendered one or more visual prompt on the display 118 (refer to FIG. 1), ensuring they are clearly visible and accessible based on the user's hand reach. The interaction generator further may optimize the placement of prompts to minimize the need for excessive hand movement or strain. Furthermore, the interaction generator 236 may dynamically adjust the one or more visual prompts based on real-time user command in order to enable the user to interact effectively with the at least one object within the final ROI bounding region. In an embodiment, adjusting of prompt positioning may consider the user's hand movement, and position of the user and hand reach. In an embodiment, the at least one of the one or more voice prompt and the one or more visual prompts may be rendered and displayed on the display 118 of the VST device 100.

The action executor 110 may enable execution of the desired actions in relation to the at least one objects selected within the final ROI bounding region. The action executor 110 may enable interaction with the one or more input command-modalities for execution of a desired action. In an embodiment, the action executor may include a command processor 243, a multimodal fusion code 245, and a response generator 246.

The command processor 243 may interpret one or more user commands to understand the intent of the user. The multimodal fusion code 245 may combine the one or more user commands with one or more ROI contents, in order to determine final intent of the user and one or more parameters needed to perform the desired action. In an example embodiment, the one or more ROI contents may be such as people, a pet, an appliance, a machine, a physical environment, or an object of a virtual environment. The response generator 246 may generate at least one final response to indicate the user completion of the desired actions executed, and eventually, may report to the user a final result upon completion of the desired actions.

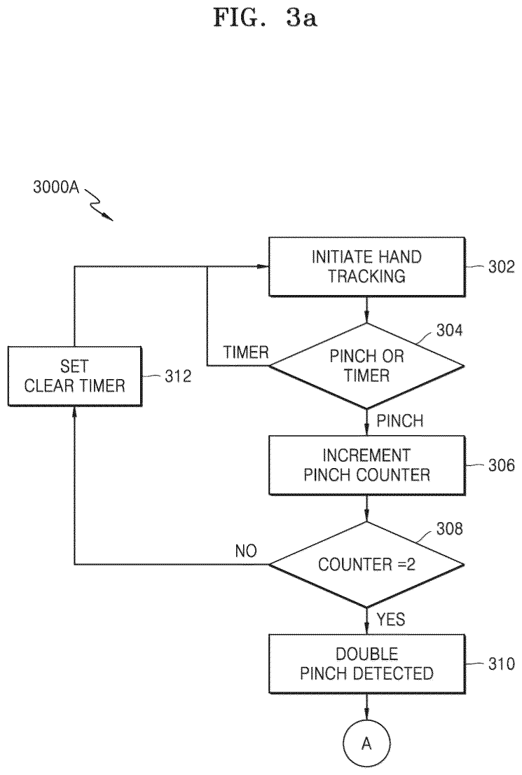

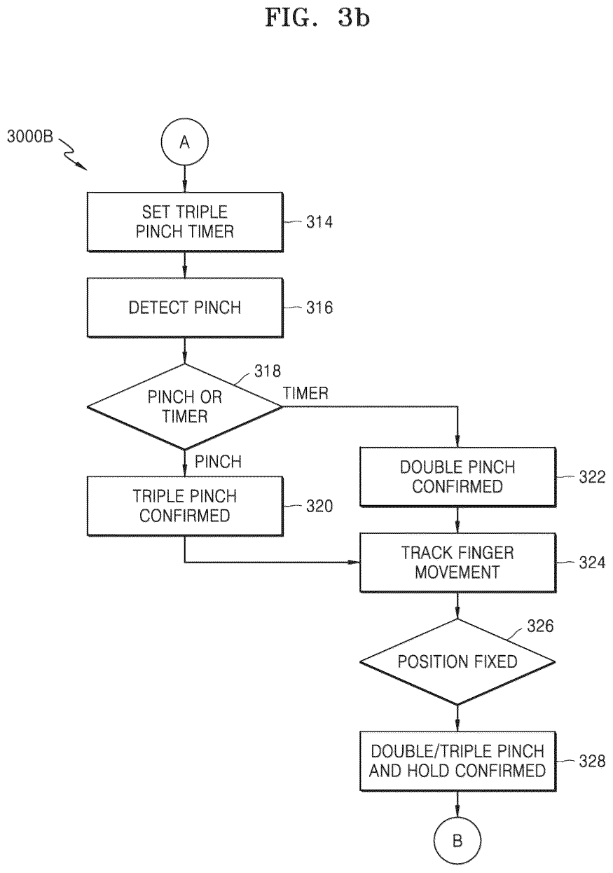

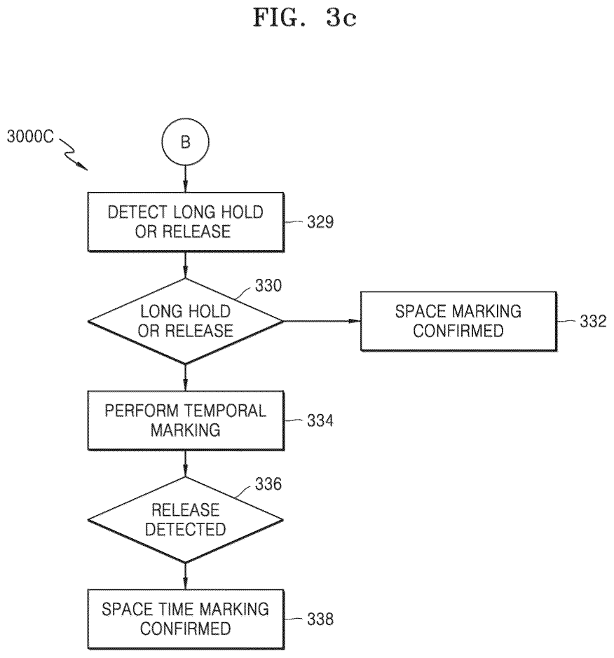

FIGS. 3A and 3C depict the flowchart for recognizing a compound Space-Time ROI marking gesture used for obtaining the final ROI bounding region, according to one or more embodiments as disclosed herein. FIG. 3A depicts a first stage, where the ROI gesture is detected. FIG. 3B depicts a second stage, where the gesture type (2D/3D) and space boundary are detected. FIG. 3C depicts a third stage, where the time boundary is detected.

FIG. 3A is a flowchart depicting a method (the first stage) for detecting and recognizing a plurality of user gestures by a gesture recognizer 104, in accordance with one or more embodiments as disclosed herein.

At operation 302, the gesture recognizer 104 initiates hand tracking of the user. At operation 304, the gesture recognizer 104 checks for any of a pinch or a timer. If a timer is detected, the gesture recognizer 104 further initiates hand tracking of the user. If a pinch is detected, at operation 306, the gesture recognizer 104 increases count of a pinch counter, followed by operation 308, where the gesture recognizer sets pinch counter at 2 counts in order to determine a double pinch user gesture. If the pinch count for a user gesture is detected as 2 counts, at operation 310, the gesture recognizer 104 determines a double pinch. If, the pinch count for a user gesture is detected as other than 2 counts, at operation 312, the gesture recognizer 104 clears the timer, thereby enabling initiation of hand tracking. The various actions in method 3000A may be performed in the order presented, in a different order or simultaneously. Further, in some embodiments, some actions listed in FIG. 3A may be omitted.

FIG. 3B is a flowchart depicting a method (the second stage) for detecting by the gesture recognizer 104 at least of a 2D user gesture and a 3D user gesture thereby detecting a spatial ROI, in accordance with one or more embodiments as disclosed herein.

At operation 314, the gesture recognizer 104 sets a triple pinch timer. At operation 316, the gesture recognizer 104 is configured to detect a pinch. At operation 318, the gesture recognizer 104 checks for a pinch or a timer. If the gesture recognizer 104 detects a pinch gesture, at operation 320, the gesture recognizer confirms a triple pinch. At operation 322, the gesture recognizer 104 confirms a double pinch if the gesture recognizer detects the triple pinch timer.

Further, at operation 324, the gesture recognizer 104 tracks one or more finger movements of the user. At operation 326, the gesture recognizer 104 checks for a position fixed for a hand gesture after one or more finger movements. If the gesture recognizer 104 detects that the position is fixed for the hand gesture after one or more the finger movements, at operation 328, at least one of a double pinch and hold, and a triple pinch and hold gesture is determined by the gesture recognizer. Therefore, a plurality of spatial marking points is obtained for generating a spatial ROI boundary. The gesture recognizer 104 further, tracks one or more finger movements of the user upon detecting an unfixed position of the hand gesture going though one or more finger movements. The various actions in method 3000B may be performed in the order presented, in a different order or simultaneously. Further, in some embodiments, some actions listed in FIG. 3B may be omitted.

FIG. 3C is a flowchart depicting a method (the third stage) for detecting a final ROI bounding region based on a plurality of temporal marking points, in accordance with one or more embodiments as disclosed herein.

At operation 329, the gesture recognizer 104 is configured to detect a long hold for at least one of a double pinch and a triple pinch during a predetermined time interval, or a release. At operation 330, the gesture recognizer 104 is configured to check whether a long hold for a time interval which exceeds the predetermined time interval, or a release of the at least one of a double pinch and a triple pinch is detected. In case that a release from the double pinch and the triple pinch is detected by the gesture recognizer 104, at operation 332, a ROI generator 106 checks a space marking. In case that a long hold for at least one of a double pinch and a triple pinch is detected by the gesture recognizer 104, at operation 334, the ROI generator 106 performs temporal marking. If the gesture recognizer 104 detects release for at least one of a double pinch and a triple pinch, at operation 336, space marking within the VST environment is confirmed. If the gesture recognizer 104 detects release for at least one of a double pinch and a triple pinch, after the ROI generator performs at least one temporal marking, at operation 338, a space-time marking for selecting a ROI is confirmed by the ROI generator engine. In an embodiment, a temporal marking is carried out by the ROI generator 106 using one or more temporal markers for one or more hand gestures, wherein the one or more temporal markers correspond to one or more time for which the plurality of user gestures is held. The various actions in method 3000C may be performed in the order presented, in a different order or simultaneously. Further, in some embodiments, some actions listed in FIG. 3C may be omitted.

In an embodiment, ROI bounding region selection may be initiated from a plurality of hand gestures of the user. Further, in an embodiment, the ROI bounding region selection may be initiated from a plurality of hand gestures including at least one of a measured eye-gaze, a measured head-gaze, and both of measured eye gaze and head gaze.

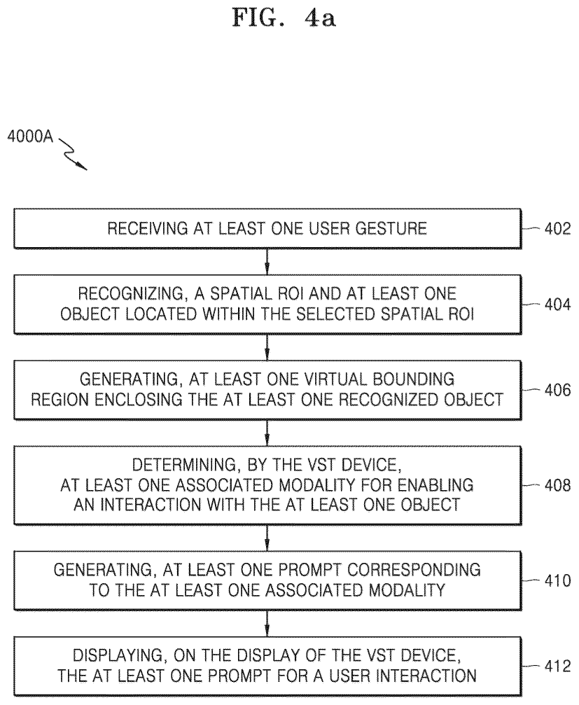

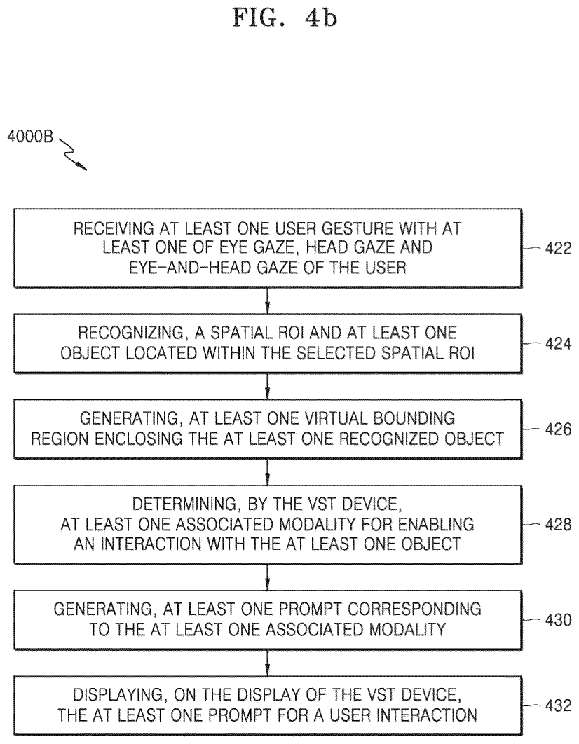

FIG. 4A is a flowchart illustrating the method for enabling gesture based object interactions in a VST device 100, according to one or more embodiments as disclosed herein. At operation 402, the method comprises receiving, by a gesture recognizer 104 of the VST device 100, at least one user gesture, wherein the at least one user gesture may be for selecting a spatial ROI within a field of view of the user. In an embodiment, the gesture recognizer 104 may receive a plurality of user gestures, and identify distinct user gestures from the received plurality of user gestures. In an embodiment, the gesture recognizer 104 identifies head orientation and eye gaze of the user along with the plurality of user gestures for enabling selection of the ROI.

At operation 404, the method comprises recognizing, by a visual analyzer 102 of the VST device 100, the spatial ROI and at least one object located within the selected spatial ROI. In an embodiment, the visual analyzer 102 determines a mode of visualization of the user viewing through the VST device 100, as an AR mode. The visual analyzer 102 further identifies the at least one object located in a physical environment of vision as viewed by the user by analyzing the physical environment of vision. The visual analyzer 102 therefore identifies, the at least one object located within the selected spatial ROI. Furthermore, the visual analyzer 102 identifies a virtual environment of vision as viewed by the user within the VST device, if a mode of visualization of the user is an immersive mode. The visual analyzer 102 recognizes by the VST device, the spatial ROI as selected by the user in order to open at least one object of the virtual world of vision within the spatial ROI.

At operation 406, the method comprises generating, by a ROI generator 106 of the VST device 100, at least one virtual bounding region enclosing the at least one recognized object located within the selected spatial ROI. The method further comprises generating by the VST device, an initial ROI boundary based on a plurality of initial ROI marking points, wherein the initial ROI boundary may be at least one of a 2D and a 3D initial ROI boundary. Further, the method comprises transforming by the VST device, spatially the initial ROI boundary based on a visual analysis of a scene as viewed by the user through the VST device and a plurality of transferal ROI marking points as received from the plurality of user gestures. Further, the method comprises estimating by the ROI generator 106, a spatial virtual bounding region for the spatial ROI, based on the plurality of user gestures. In an embodiment, the method comprises scaling a size of the initial ROI boundary based on the plurality of user gestures to generate the at least one virtual bounding region. In an example embodiment, the method further comprises scaling the size of the initial ROI boundary based on relative positions of hands of the user changed by the plurality of user gestures. The method further comprises correlating by the RoI generator 106, the plurality of user gestures, with at least one temporal marker, wherein the at least one temporal marker is a time for which the plurality of user gestures is held.

At operation 408, the method comprises determining, by an ROI processor 108 of the VST device 100, at least one associated modality for enabling an interaction with the at least one object located within the at least one generated virtual bounding region. The ROI processor 108 determines at least one likely input command for user interaction with the at least one object located within the spatial ROI, based on the at least one object and at least one of at least a textual element, at least an audio element and at least a visual element located with the at least one object within the spatial ROI. Further, the ROI processor 108 determines a most likely associated modality by which the user specifies the likely input command.

At operation 410, the method comprises generating, by the ROI processor 108 of the VST device 100, at least one prompt corresponding to the at least one associated modality based on a relative position of user hand and the ROI. In an embodiment, the at least one prompt may be at least one of a voice prompt and a visual prompt rendered by the ROI processor 108 of the VST device 100.

At operation 412, the method comprises displaying, on the display 118 of the VST 100, the at least one prompt for a user interaction. In an embodiment, the at least one prompt may be dynamically adjusted in position on the display 118 based on real-time input from the user and changes its position in the VST environment taking into account both the user's movement, position and hand reach.

The various actions in method 4000A may be performed in the order presented, in a different order or simultaneously. Further, in some embodiments, some actions listed in FIG. 4A may be omitted.

FIG. 4B a flowchart illustrating the method for enabling user gesture based object interactions in a VST device 100, according to one or more embodiments as disclosed herein.

At operation 422, the method comprises receiving, by a gesture recognizer 104 of the VST device 100, at least one user gestures along with at least one of, eye gaze, head gaze, and both eye-and-head gaze of the user. The at least one user gesture along with the at least one of, eye gaze, head gaze, and both eye-and-head gaze of the user may be used for selecting a spatial ROI within a field of view of the user. The gesture recognizer 104 may identify distinct user gestures from the at least one user gesture along with at least one of, eye gaze, head gaze, and both eye-and-head gaze of the user.

At operation 424, the method comprises recognizing, by a visual analyzer 102 of the VST device 100, the spatial ROI and at least one object located within the selected spatial ROI. In an embodiment, the visual analyzer 102 determines a mode of visualization of the user viewing through the VST device 100, as an AR mode. The visual analyzer 102 further identifies the at least one object located in a physical environment of vision as viewed by the user by analyzing the physical environment of vision. The visual analyzer 102 therefore identifies, the at least one object located within the selected spatial ROI. Furthermore, the visual analyzer 102 identifies a virtual environment of vision as viewed by the user within the VST device, if a mode of visualization of the user is an immersive mode. The visual analyzer 102 recognizes by the VST device, the spatial ROI as selected by the user in order to open at least one object of the virtual world of vision within the spatial ROI.

At operation 426, the method comprises generating, by a ROI generator 106 of the VST device 100, at least one virtual bounding region enclosing the at least one recognized object located within the selected spatial ROI. The method further comprises generating by the VST device, an initial ROI boundary based on a plurality of initial ROI marking points, wherein the initial ROI boundary may be at least one of a 2D and a 3D initial ROI boundary. Further, the method comprises transforming by the VST device, spatially the initial ROI boundary based on a visual analysis of a scene as viewed by the user through the VST device and a plurality of transferal ROI marking points as received from the plurality of user gestures. Further, the method comprises estimating by the ROI generator 106, a spatial virtual bounding region for the spatial ROI, based on the plurality of user gestures. The method further comprises correlating by the ROI generator 106, the plurality of user gestures, with at least one temporal marker, wherein the at least one temporal marker is a time for which the plurality of user gestures is held.

At operation 428, the method comprises determining, by an ROI processor 108 of the VST device 100, at least one associated modality for enabling an interaction with the at least one object located within the at least one generated virtual bounding region. The ROI processor 108 determines at least one likely input command for user interaction with the at least one object located within the spatial ROI, based on the at least one object and at least one of at least a textual element, at least an audio element and at least a visual element located with the at least one object within the spatial ROI. Further, the ROI processor 108 determines a most likely associated modality by which the user specifies the likely input command.

At operation 430, the method comprises generating, by the ROI processor 108 of the VST device 100, at least one prompt corresponding to the at least one associated modality based on a relative position of user hand and the ROI. In an embodiment, the at least one prompt may be at least one of a voice prompt and a visual prompt rendered by the ROI processor 108.

At operation 432, the method comprises displaying, on the display 118 of the VST 100, the at least one prompt for a user interaction. In an embodiment, the generated at least one prompt may be dynamically adjusted in position on the display 118 based on real-time input from the user and changes its position in the VST environment taking into account both the user's movement, position and hand reach. The various actions in method 4000B may be performed in the order presented, in a different order or simultaneously. Further, in some embodiments, some actions listed in FIG. 4B may be omitted.

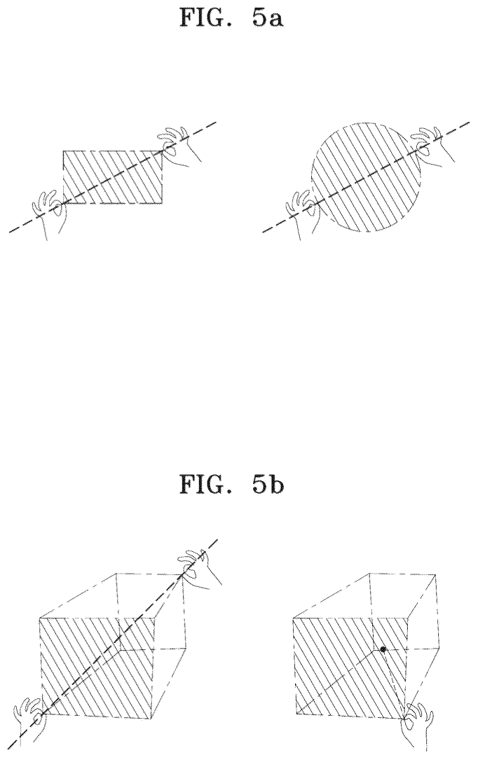

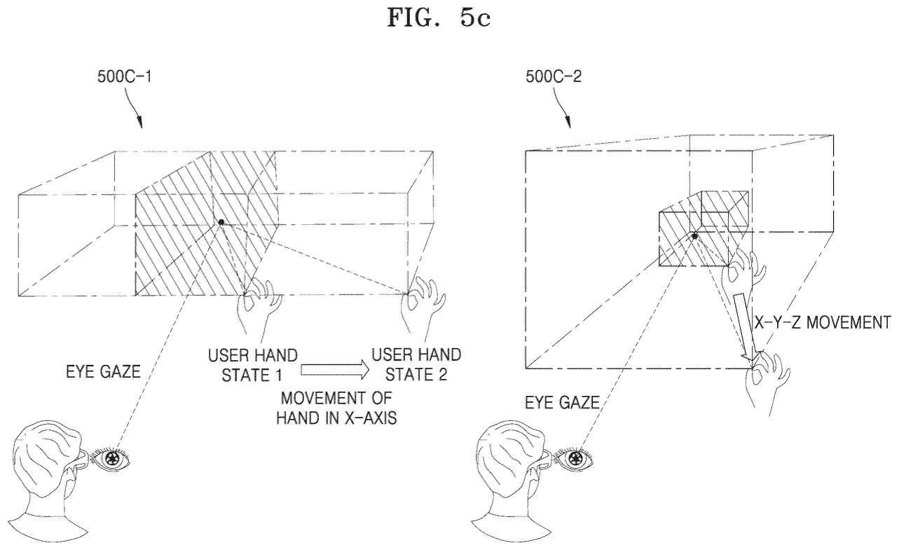

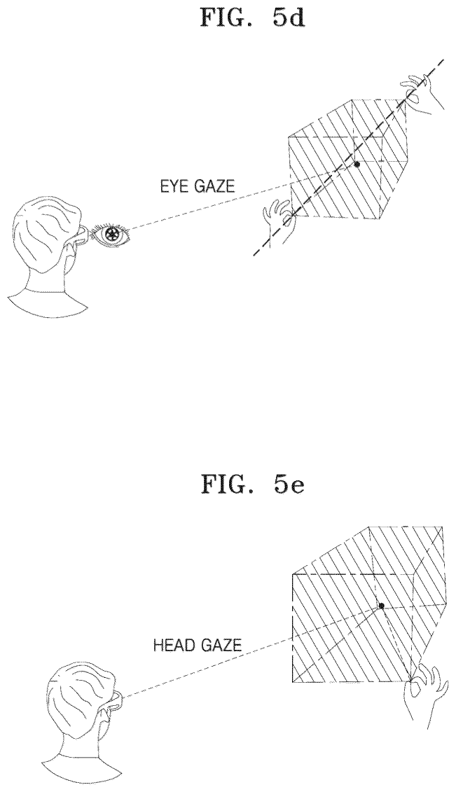

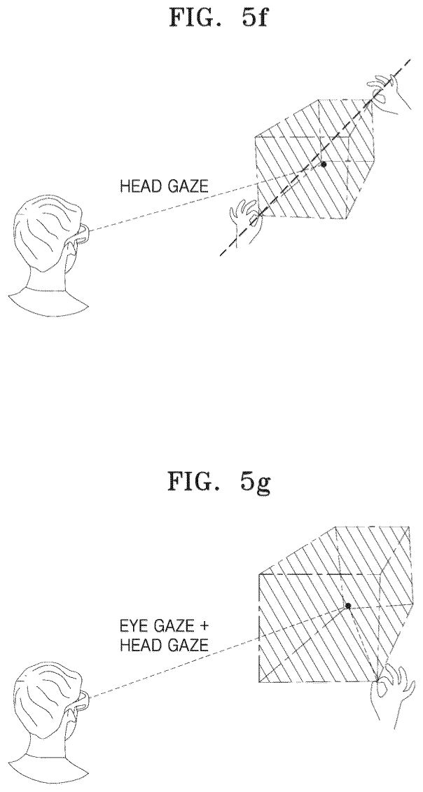

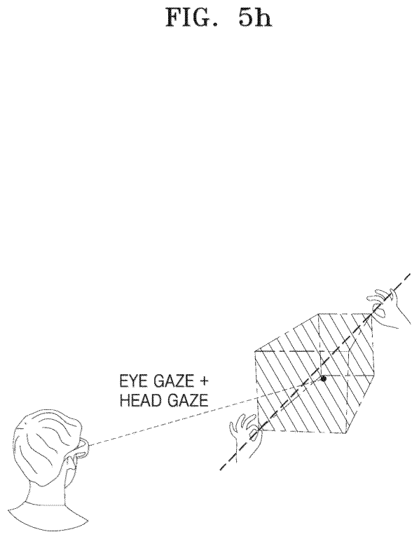

FIGS. 5A and 5B are views illustrating methods of selecting a 2D ROI bounding region selection and a 3D ROI bounding region for an AR mode of visualization and an immersive mode of visualization of the user viewing through the VST device 100 respectively, according to one or more embodiments as disclosed herein. As in FIGS. 5A and 5B, the ROI bounding region is selected based on a plurality of hand gestures of the user by translating and scaling of a ROI based on the plurality of hand gestures. In an embodiment, when a ROI selection gesture is detected for a 2D ROI selection, a rectangular ROI is generated. The rectangular region is generated in a 2D space, from two pinch points, wherein the two pinch points are two opposite corners of the rectangular ROI. In an example embodiment, the rectangular ROI has its bottom edge parallel to floor-plane. Alternatively, the selection region may be a circle in shape. The circle is generated such that the two pinch-points are the two opposite ends of a diameter of the circle.

Further, in an embodiment, a 3D ROI selection gesture is detected by the ROI generator, and a cuboid ROI is generated for selection. The cuboid is generated from three pinch points, wherein the three pinch points are two diagonal corners of the cuboid. The bottom of the cuboid ROI is parallel to a floor plane. Furthermore, the 3D ROI bounding region may be selected from a single hand gesture.

In embodiments in FIG. 5A and 5B, in case in which positions of hands of the user are changed by the plurality of user gestures, the selection region may be redrawn as per new pinch points. The VST device 100 may scale a size of the selection region based on relative positions of hands of the user changed by the plurality of user gestures.

FIG. 5C is a view illustrating the method of generating a 3D ROI from a plurality of one hand gestures of a user and using an eye gaze. In an embodiment, a cuboid is generated from a measured eye gaze and triple pinch points, wherein the measured eye gaze and triple pinch points may be a diagonal of a bottom plane of the cuboid. In an embodiment, the bottom plane of the cuboid ROI is parallel to the floor plane. In an embodiment illustrated in 500c-1 of FIG. 5C, a size of the cuboid along the x-axis may be changed (expanded or reduced) as the hand of the user moves in the x-axis direction by the plurality of one hand gestures. In an embodiment illustrated in 500c-2 of FIG. 5C, a size of the cuboid along at least one of the x-axis, y-axis, or z-axis may be changed as the hand of the user moves along the at least one of the x-axis direction, the y-axis direction, or the z-axis direction by the plurality of one hand gestures.

FIG. 5D a view illustrating the method of generating a 3D ROI from a plurality of two hand gestures of a user and using the user's head gaze, according to one or more embodiments as disclosed herein. In an embodiment, a cuboid is generated from a measured eye gaze and triple pinch points. The triple pinch points may be a diagonal of a bottom plane of the cuboid. The measured eye gaze may be a vertex of a bottom plane of the cuboid. In an embodiment, the bottom plane of the cuboid ROI may be parallel to the floor plane. In an embodiment illustrated in FIG. 5D, a size of the cuboid along at least one of the x-axis, y-axis, or z-axis may be changed (expanded or reduced) as the hand of the user moves along the at least one of the x-axis direction, the y-axis direction, or the z-axis direction by the plurality of two hand gestures.

FIG. 5E depicts the method of generating a 3D ROI from a plurality of one hand gestures of a user and using a user's eye gaze, according to one or more embodiments as disclosed herein. In an embodiment, a cuboid is generated from a measured eye gaze of the user and triple pinch points. The measured head gaze and triple pinch points may be a diagonal of a bottom plane of the cuboid. In an embodiment, the bottom plane of the cuboid ROI is parallel to the floor plane. In an embodiment illustrated in FIG. 5E, a size of the cuboid along at least one of the x-axis, y-axis, or z-axis may be changed (expanded or reduced) as the hand of the user moves along the at least one of the x-axis direction, the y-axis direction, or the z-axis direction by the plurality of one hand gestures.

FIG. 5F depicts the method of generating a 3D ROI from a plurality of two hand gestures of a user and using a user's head gaze, according to one or more embodiments as disclosed herein. In an embodiment, a cuboid is generated from a measured head gaze and triple pinch points. The triple pinch points may be a diagonal of a bottom plane of the cuboid. The measured head gaze may be a vertex of a bottom plane of the cuboid. In an embodiment, the bottom plane of the cuboid ROI is parallel to the floor plane. In an embodiment illustrated in FIG. 5F, a size of the cuboid along at least one of the x-axis, y-axis, or z-axis may be changed (expanded or reduced) as the hand of the user moves along the at least one of the x-axis direction, the y-axis direction, or the z-axis direction by the plurality of two hand gestures.

FIG. 5G depicts the method of generating a 3D ROI from a plurality of one hand gestures of a user and using both the user's eye gaze and head gaze, according to one or more embodiments as disclosed herein. In an embodiment, a cuboid is generated from a user's eye gaze and head gaze and triple pinch points. The measured head gaze and triple pinch points may be a diagonal of a bottom plane of the cuboid. In an embodiment, the bottom plane of the cuboid ROI is parallel to the floor plane. In an embodiment illustrated in FIG. 5G, a size of the cuboid along at least one of the x-axis, y-axis, or z-axis may be changed (expanded or reduced) as the hand of the user moves along the at least one of the x-axis direction, the y-axis direction, or the z-axis direction by the plurality of one hand gestures.

FIG. 5H depicts the method of generating a 3D ROI from a plurality of two hand gestures of a user and using the user's eye gaze and head gaze, according to one or more embodiments as disclosed herein. In an embodiment, a cuboid is generated from a measured user's head gaze and triple pinch points. The triple pinch points may be a diagonal of a bottom plane of the cuboid. The measured eye gaze and head gaze may be a vertex of a bottom plane of the cuboid. In an embodiment, the bottom plane of the cuboid ROI is parallel to the floor plane. In an embodiment illustrated in FIG. 5H, a size of the cuboid along at least one of the x-axis, y-axis, or z-axis may be changed (expanded or reduced) as the hand of the user moves along the at least one of the x-axis direction, the y-axis direction, or the z-axis direction by the plurality of two hand gestures.

In an example embodiment, while marking a spatial-temporal ROI bounding region with a single hand gesture, a triple pinch and hold gesture with index and thumb finger may result in generating a 3D ROI bounding region at a first space within the VST environment. A quick switch to middle pinch may result in enabling the first 3D ROI bounding region to a movable state. Further, hand in motion with middle pinch may result in translating the 3D bounding region from the first space to a second space, relative to hand motion. A quick switch to index pinch may result in generating a 3D ROI bounding region at the second space, within the VST environment. Further, hand movement along X-axis may result in expansion of the 3D ROI bounding region at the second space, relative to hand motion along X-axis. Further, release of fingers may result in selection of an expanded 3D ROI bounding region, wherein the expanded 3D ROI bounding region is obtained from the 3D ROI bounding region at the second space within the VST environment.

Embodiments herein are further exemplified by the following examples. However, the following examples are illustrating application area(s) of embodiments disclosed herein and are not limiting, and embodiments as disclosed herein may be implemented in diverse fields of application.

### EXAMPLE 1

A VST AR mode Application: a User Views a Washing Machine 610 in Real World

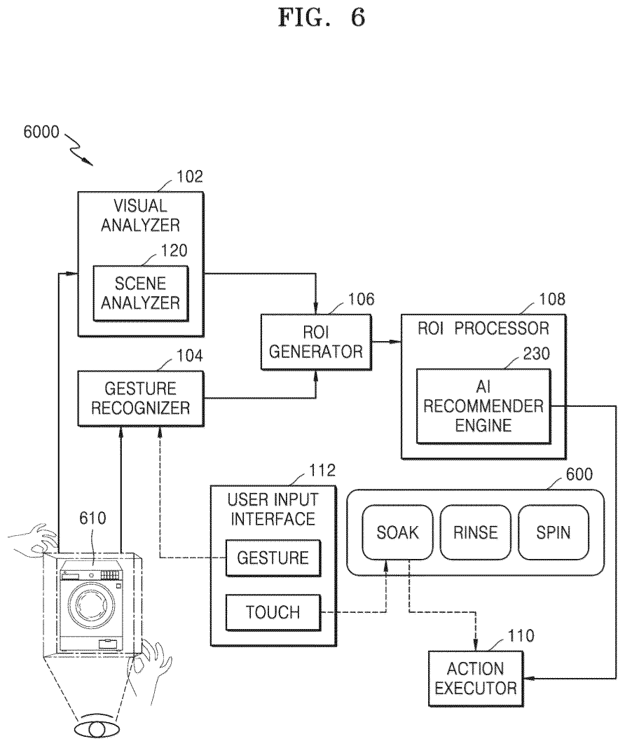

FIG. 6 depicts an example use cases 6000 of a proposed VST device, according to embodiment. As depicted in FIG. 6, a user using the VST device views a washing machine 610 in the real world. The mode of visualization of the VST device is an AR mode of vision, wherein a physical environment is analyzed by a visual analyzer. The user makes a triple pinch and hold gesture in order to select the washing machine entity within a VST environment, wherein the VST environment is a physical environment of vision viewed through the VST device. A user input interface 112 of the VST device enables the user to input to the VST device the triple pinch and hold gesture. A gesture recognizer 104 of the VST device analyses and recognizes the user gesture for selection of a 3D ROI bounding region. Further, the visual analyzer 102 analyses the physical environment of vision by a scene analyzer of the visual analyzer. Output from the visual analyzer 102 and the gesture recognizer 104 is received by a ROI generator 106, wherein the ROI generator may generate a box shaped 3D bounding region. A boundary generator engine of the ROI generator generates a 3D initial spatial-temporal ROI boundary. Further, a transformation computation engine of the ROI generator, computes for scaling dimension of the 3D initial spatial-temporal ROI boundary, based on dimension of the washing machine entity inside the 3D initial spatial-temporal ROI boundary and field of view of the VST device. A ROI computation engine of the ROI generator generates a final 3D ROI bounding region, based on inputs from the gesture recognizer 104 and one or more contents viewed in the field of view of the VST device. In an embodiment, the one or more contents may include the washing machine entity alone, the washing machine entity along with a living object within the field of view of the VST device, the washing machine entity along with a non-living object within the field of view of the VST device and so on. A ROI processor 108 of the VST device identifies the washing machine entity within the field of view. Upon identifying the washing machine entity, a recommender AI engine of the ROI processor 108 recommends to the user one or more controlling parameters for the washing machine entity, with a suitable modality for controlling. In an example, a touch modality for controlling the washing machine entity is recommended. The recommender AI engine of the ROI processor 108 further generates a prompt user interface (UI) 600 including one or more touch buttons corresponding to controlling the washing machine entity, wherein the one or more touch buttons are rendering to the user interface. The prompt UI 600 may be displayed on the display 118 (refer to FIG. 1). The ROI processor 108 further fetch external information such as information on controlling parameters for the washing machine entity from a cloud server in order to recommend the one or more controlling parameters for the washing machine entity. Thus, the ROI processor prompts the user of the VST device to input at least one user command through the prompt UI 600 displayed on the display 118, in relation to controlling the washing machine entity. An action executor 110 of the VST device, may process a touch-based user command and fuse touch action perfumed on the one or more touch buttons to an action for controlling the washing machine entity. Further, the action executor 110 receives from the ROI processor 108, external information such as information on controlling parameters for the washing machine entity. Thus, the action executor 110 executes the action for controlling the washing machine entity through the touch action on the one or more touch buttons included in the prompt UI 600. Finally, the action executor generates a response in relation to placing the washing machine entity to an operating mode, as required by the user.

### Example 2

### A VST AR Mode Application: A User Views an Item of Interest in Real World

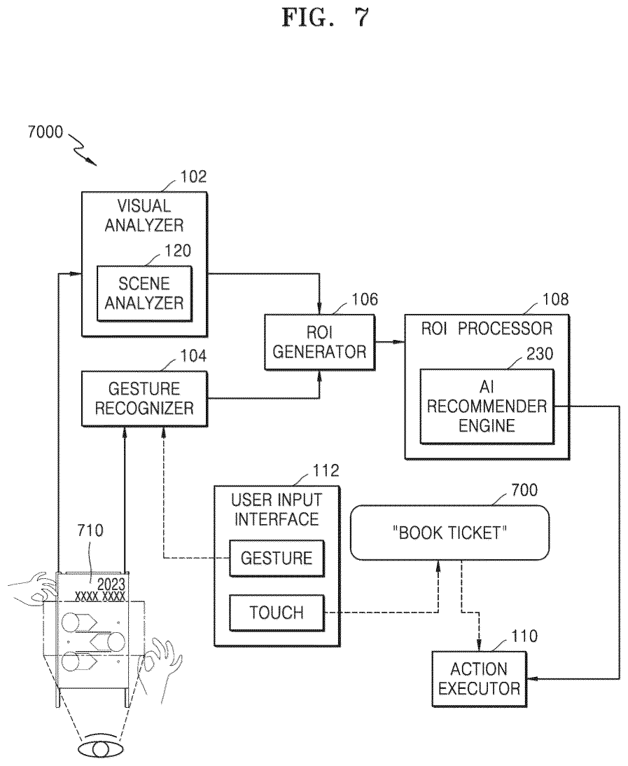

FIG. 7 depicts example use case 7000 of a proposed VST device, according to embodiment. As depicted in FIG. 7, a user using the VST device views an item of interest 710 of a real world. The mode of visualization of the VST device is an AR mode of vision, wherein a physical environment is analyzed by a visual analyzer. The user makes a double pinch and hold gesture in order to select the item of interest 710 within a VST environment, wherein the VST environment is a physical environment of vision viewed through the VST device. A user input interface 112 of the VST device enables the user to input to the VST device the double pinch and hold gesture. A gesture recognizer of the VST device analyses and recognizes the user gesture for selection of a 2D ROI bounding region. Further, the visual analyzer 102 analyses the physical environment of vision by a scene analyzer of the visual analyzer. Output from the visual analyzer and the gesture recognizer 104 is received by a ROI generator 106, wherein the ROI generator 106 may generate a 2D bounding region. A boundary generator engine of the ROI generator generates a 2D initial spatial-temporal ROI boundary. Further, a transformation computation engine of the ROI generator, computes for scaling dimension of the 2D initial spatial-temporal ROI boundary, based on a dimension of a region of interest inside the 2D initial spatial-temporal ROI boundary and field of view of the VST device. A ROI computation engine of the ROI generator generates a final 2D ROI bounding region, based on inputs from the gesture recognizer and one or more contents viewed in the field of view of the VST device. In an embodiment, the one or more contents may include the item of interest 710 alone, the item of interest 710 along with a living object within the field of view of the VST device, the item of interest 710 along with a non-living object within the field of view of the VST device and so on. A ROI processor 108 of the VST device identifies the item of interest 710 within the field of view. Upon identifying the item of interest 710, a recommender AI engine of the ROI processor 108 recommends to the user an action with a suitable modality in relation to the item of interest 710. In an example, the action is an action of booking a ticket as recommend to the user with a touch modality for accomplishing the action. The AI recommender engine 230 of the ROI processor further generates a prompt user interface (UI) 700 including a touch button corresponding to the action of booking the ticket, wherein the touch button is rendered to the user interface. The prompt UI 700 may be displayed on the display 118 (refer to FIG. 1). The ROI processor 108 further fetch external information from a cloud server, such as information on the type of the item of interest 710 such as a poster of interest for a musical event, wherein the external information is fetched for recommending the action of booking the ticket. Thus, the ROI processor 108 prompts the user of the VST device to input a user command through the prompt UI 700 displayed on the display 118, in relation to booking the ticket. An action executor 110 of the VST device, may process a touch-based user command and fuse touch action perfumed on the touch buttons to an action for booking the ticket. Thus, the action executor 110 executes the action of booking the ticket for a musical event by opening a booking website for the musical event. The action executor 110 further may fetch from a cloud server information on the booking website for the musical event. Finally, the action executor 110 generates a response in relation to booking confirmation of the ticket, as required by the user.

### Example 3

A VST AR Mode Application: A user is Looking at an Empty Wall

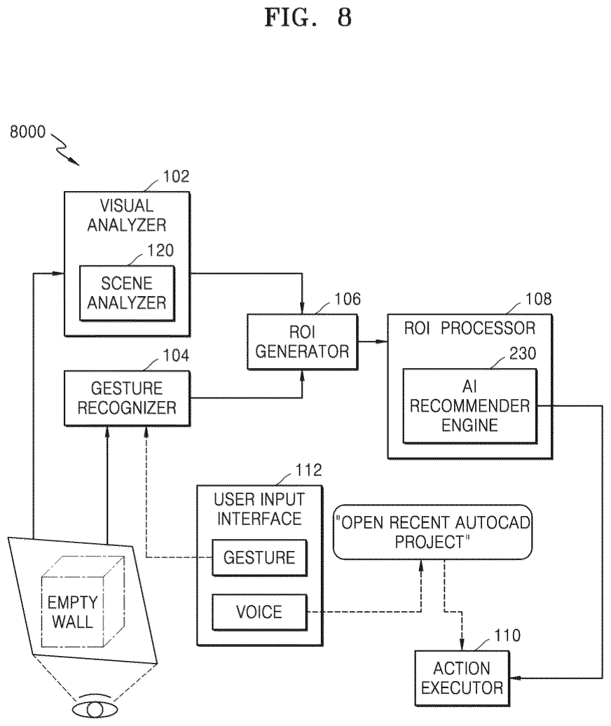

FIG. 8 depicts example use case 8000 of a proposed VST device, according to embodiment. As depicted in FIG. 8, a user using the VST device views an empty wall of a real world. The mode of visualization of the VST device is an AR mode of vision, wherein a physical environment is analyzed by a visual analyzer 102. The user makes a triple pinch and hold gesture in order to select a region of interest in the empty wall, wherein the VST environment is a physical environment of vision viewed through the VST device. A user input interface 112 of the VST device enables the user to input to the VST device the triple pinch and hold gesture. A gesture recognizer 104 of the VST device analyses and recognizes the user gesture for selection of a 3D ROI bounding region. Further, the visual analyzer 102 analyses the physical environment of vision by a scene analyzer of the visual analyzer 102. Output from the visual analyzer 102 and the gesture recognizer 104 is received by a ROI generator 106, wherein the ROI generator 106 may generate a 3D bounding region. A boundary generator engine of the ROI generator 106 generates a 3D initial spatial-temporal ROI boundary. Further, a transformation computation engine of the ROI generator 106, computes for scaling dimension of the 3D initial spatial-temporal ROI boundary, based on a dimension of the region of interest in the empty wall and field of view of the VST device. A ROI computation engine of the ROI generator 106 generates a final 3D ROI bounding region, based on inputs from the gesture recognizer 104 and one or more contents viewed in the field of view of the VST device. In an embodiment, the one or more contents may include the region of interest alone, the region of interest along with a living object within the field of view of the VST device, the region of interest along with a non-living object within the field of view of the VST device and so on. A ROI processor of the VST device identifies an empty region of interest within the field of view. Upon identifying the empty region of interest, an AI recommender engine 230 of the ROI processor 108 recommends to the user an action with a suitable modality in relation to processing the empty region of interest. In an example, the action is taking a voice input from the user for opening a recent AutoCAD project within the empty region of interest. The AI recommender engine 230 of the ROI processor 108 further create automatic opening of a microphone for accomplishing the action of taking a voice input from the user. Thus, the ROI processor 108 prompts the user of the VST device to input a user command through an open microphone rendered in the UI. An action executor 110 of the VST device, may process a voice based user command and fuse the user command to a most recently saved AutoCAD project. Thus, the action executor 110 executes the action of opening the most recently saved AutoCAD project through the voice modality of the user command. Finally, the action executor 110 generates a response for opening the most recently saved AutoCAD project within the empty region of interest, as required by the user.

### Example 4

### A VST Immersive Mode Application: A User Views Through a Virtual Reality (VR) Application

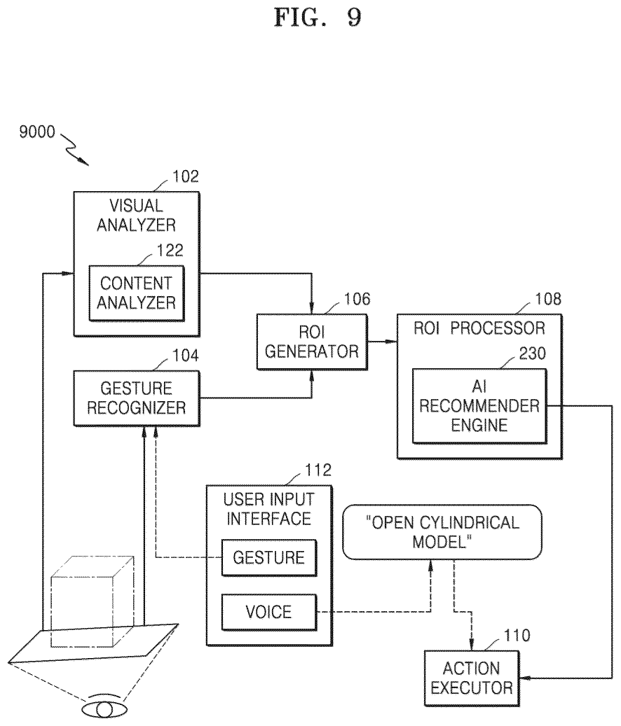

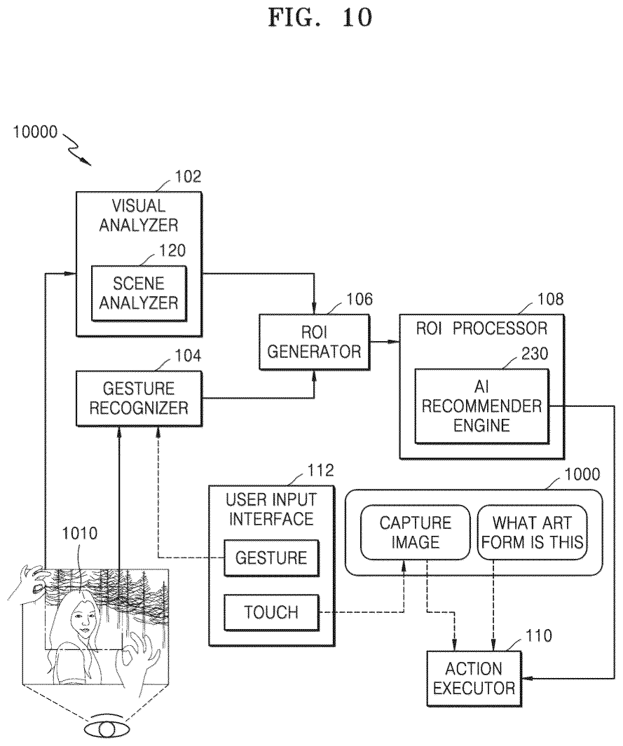

FIG. 9 depicts example use case 9000 of a proposed VST device, according to embodiment. As depicted in FIG. 9, a user using the VST device views through an immersive APP and makes a triple pinch and hold gesture in order to generate a ROI within a VST environment. The mode of visualization of the VST device is an immersive mode of vision, wherein device content within a virtual environment is analyzed by a visual analyzer 102. The user may input a plurality of user gestures comprising the triple pinch and hold gesture to the VST device through a user input interface 112 of the VST device. A gesture recognizer 104 of the VST device analyses and recognizes the plurality of user gesture for selection of a 3D ROI bounding region within the VST environment. Further, the visual analyzer 102 analyses the device content within the virtual environment by a content analyzer of the visual analyzer 102. Output from the visual analyzer 102 and the gesture recognizer 104 are received by a ROI generator 106, wherein the ROI generator 106 may generate a box shaped 3D bounding region. A boundary generator engine of the ROI generator 106 generates a 3D initial spatial-temporal ROI boundary. Further, a transformation computation engine of the ROI generator 106, computes for scaling dimension of the 3D initial spatial-temporal ROI boundary, based on a canvas inside the 3D initial spatial-temporal ROI boundary and field of view of the VST device. A ROI computation engine of the ROI generator 106 generates a final 3D ROI bounding region, based on inputs from the gesture recognizer 104 and one or more contents as viewed within a virtual environment in the field of view of the VST device. In an example embodiment, the one or more contents as viewed within a virtual environment in the field of view of the device may be such as without limitation, 3D design prototypes, art and sculpture, architectural visualizations, engineering experiments (e.g., virtual machinery) and so on. A ROI processor of the VST device identifies an empty 3D ROI bounding region within the field of view of the VST device. Upon identifying the empty 3D ROI bounding region, an AI recommender engine 230 of the ROI processor 108 recommends to the user to input user command for processing with a suitable modality the empty 3D ROI bounding region. In an example, a voice modality for processing the empty 3D ROI bounding region is recommended. The AI recommender engine 230 of the ROI processor 108 further generates automatically a microphone icon for enabling the user to input the user command through an open microphone, wherein the microphone icon is rendering to the user input interface 112. The ROI processor 108 prompts the user of the VST device to input at least one user command through the microphone icon rendered in the UI, in relation to processing the empty 3D ROI bounding region. The user command is placing of a cylindrical model within the empty 3D ROI bounding region. An action executor 110 of the VST device, may process the user command and fuse a voice action perfumed on the microphone icon to an action corresponding to placing a cylindrical model within the empty 3D ROI bounding region. The action executor 110 further fetch external information such as information on a VR app from a cloud server in order to execute user command for processing the empty 3D ROI bounding region. Thus, the action executor 110 executes the action for processing the empty 3D ROI bounding region, through the voice action on the microphone icon. Finally, the action executor 110 generates a response in relation to placing the cylindrical model within the empty 3D ROI bounding region, as required by the user.

### Example 5

### A VST AR Mode Application: A User Views a Real World Content and Sees an Activity of Interest

FIG. 10 depicts example use case 10000 of a proposed VST device, according to embodiment. As depicted in FIG. 10, a user using the VST device views an activity of interest 1010 in a real world. The mode of visualization of the VST device is an AR mode of vision, wherein a physical environment is analyzed by a visual analyzer 102. The user makes a double pinch and hold gesture in order to select the activity of interest 1010 within a VST environment, wherein the VST environment is a physical environment of vision viewed through the VST device. A user input interface 112 of the VST device enables the user to input to the VST device the double pinch and hold gesture. A gesture recognizer 104 of the VST device analyses and recognizes the user gesture for selecting a 2D ROI bounding region. Further, the visual analyzer 102 analyses the physical environment of vision by a scene analyzer of the visual analyzer 102. Output from the visual analyzer 102 and the gesture recognizer 104 is received by a ROI generator 106, wherein the ROI generator 106 may generate a 2D bounding region. A boundary generator engine of the ROI generator 106 generates a 2D initial spatial-temporal ROI boundary. Further, a transformation computation engine of the ROI generator 106, computes for scaling dimension of the 2D initial spatial-temporal ROI boundary, based on salient information inside the 2D initial spatial-temporal ROI boundary and field of view of the VST device. A ROI computation engine of the ROI generator 106 generates a final 2D ROI bounding region, based on inputs from the gesture recognizer 104 and one or more contents viewed in the field of view of the VST device. In an embodiment, the one or more contents may include the activity of interest 1010 alone, the activity of interest 1010 along with a living object within the field of view of the VST device, the activity of interest 1010 along with a non-living object within the field of view of the VST device and so on. A ROI processor of the VST device identifies the activity of interest 1010 within the field of view. Upon identifying the activity of interest 1010, an AI recommender engine 230 of the ROI processor 108 recommends to the user a first action and a second action with a suitable modality in relation to the activity of interest 1010. In an example, the first action is an action of capturing an image in the activity of interest 1010, as recommend to the user with a first touch-plus-voice modality for accomplishing the first action. In an example, the second action is an action of identifying type of the activity of interest 1010, as recommend to the user with a second touch-plus-voice modality for accomplishing the second action. The ROI processor 108 identifies the activity of interest 1010, such as the activity of interest 1010 is a person performing a specific art form. The AI recommender engine 230 of the ROI processor 108 further generates a prompt user interface (UI) 1000. The prompt UI 1000 comprises a first touch button corresponding to the first action, wherein the first touch button is generated based on a first user command from the user received by the ROI processor 108 through a first voice modality. Further, the prompt UI 1000 further comprises a second touch button corresponding to the second action, wherein the second touch button is generated by the AI recommender engine 230 of the ROI processor 108 based on a second user command from the user received by the ROI processor 108 through a second voice modality. The first touch button and the second touch buttons are rendering to the user input interface 112 of the VST device. Thus, the ROI processor 108 prompts the user of the VST device to input at least two user commands via the first touch button and the second touch button, rendered in the UI. An action executor 110 of the VST device, may process touch-based the first user command and the second user command and fuse touch action perfumed on the first touch button and the second touch button to corresponding first action and the second action respectively. Further, the action executor 110 fetch from a cloud server information on a type of the specific art form. Therefore, the action executor 110 executes the first action of capturing an image through the touch action on the first touch button of the prompt UI 1000. Further, the action executor engine executes the second action of identifying the type of the specific art form through the touch action on the second touch button of the prompt UI 1000. Finally, the action executor 110 generates a first response and a second response in relation to the first action and the second action respectively, as required by the user.

Embodiments herein disclose systems and methods to enable marking 2D and 3D spatial-temporal regions in a VST environment using a fluid and natural gesture interaction, and enabling the user to seamlessly perform associated functions using the most convenient modality for a desired action.

Embodiments herein disclose a method to identify user hand gesture and assign bounding box to the determined gesture to mark a region in the virtual space in a video see through (VST) device.

Embodiments herein disclose a method to determine the context of the marked region in the virtual space by analyzing the type of bounding box (2D or 3D) and understanding of the content present inside the bounding box corresponding relevant content outside the bounding box.

Embodiments herein disclose a method to assign a set of functions to the understood context inside the bounding box to the user to perform actions with respect to the marked/bounded region in space wherein the action includes explicit voice input or any other actions that the user intends on that same marked/bounded region.

Embodiments herein determine the type of gesture made using user's hand and assigning bounding box to the made gesture, letting user to mark a region in the space while using a VST device.

Embodiments herein determine the context of the marked region in space by analyzing the type of bounding box generated (2D or 3D) along with understanding the content present inside the bounding box and the relevant content outside the bounding box.

Embodiments herein assign and provide the right set of functions to the understood inside the bounding box to the user, to quickly perform action with respect to the marked/bounded region in space; along with providing option for explicit voice input to perform any other actions that the user intends on that same marked/bounded region.

Embodiments herein disclose a method for enabling gesture based object interactions in a VST device. On receiving a gesture indicative of a selection of a region of interest within a field of view during an immersive mode or a pass through mode of the VST device, embodiments herein may recognize one or more objects including an application, an appliance, a real object and a virtual object within the selected region of interest. Embodiments herein determine one or more functions associated with each object, using a pre-trained AI model and provide the determined functions for each object as one or more prompts for real and/or virtual interactions of the user with the object within the region of interest, the determined functions for each object. On detecting a pre-defined gesture (such as a double pinch and hold gesture) for selecting a 2D of a region of interest, embodiments herein detect a triple pinch and hold gesture for 3D selection for a region of interest, wherein the pre-defined gesture is held for a pre-defined time interval to recognize objects in the field of view over the detected time interval.

Embodiments herein may detect an AR mode of operation of the VST device and trigger a user scene analyzer of the field of view of the user. Embodiments herein may further detect an immersive mode of operation of the VST device and triggering content analyzer of the field of view of the user.

Embodiments herein may generate a boundary in the user field of view based on transformation computation to scale the region of interest relative to the analysis of the scene;

Embodiments herein may fuse a user input for the prompt and the region of interest contents to execute a user intended action.

Embodiments herein may prepare a secondary input such as a user command. The RoI processor understands the ROI contents using AI engines for vision/text/audio/video etc. The recommender AI recommends one or more likely secondary modalities (which may result in preparing the device for secondary input (e.g., Automatic mic opening)). The recommender AI recommends one or more likely user commands (results in shortcuts for likely actions to be shown to the user for quick interactions). The recommender AI recommends creation of one or more touch UI buttons that will be rendered and shown to the user, along with opening the microphone (mic) for voice input. Embodiments herein may interpret and take one or more actions. Embodiments herein may interpret the secondary input or user command in conjunction with the ROI contents. Embodiments herein may perform the requested user action(s).

Embodiments herein disclose spatial-temporal marking using a VST device with an AR mode of vision and an immersive mode of vision. A spatial boundary generator estimates an initial ROI boundary based on the raw inputs produced by the gesture recognizer 104. A temporal boundary generator correlates the recognized gesture with the timestamps of interactions and creates the timeline boundary for the ROI. A transformation computation engine generates the transformation function to scale/rotate/move the ROI boundary based on the visual analysis of the scene as well as user's eye gaze and head orientation. The transformation computation engine computes the translate transform (position) and scale transform (size) that needs to be applied to the absolute user inputs to convert them into points corresponding to the space the user is interacting with. The transformation computation engine further computes the rotate transform (orientation/angle) to be applied to the absolute inputs based on the user's head orientation. A ROI computation engine transforms the ROI boundary generated by the boundary generator using the transformation produced by the transformation computation module. The transformation computation engine computes the final composite transform based on inputs from a transformation computation block by considering the nature of the gesture (2D/3D) by user, and applies this to the spatial boundary provided by the boundary generator engine 204 of the ROI generator 106.

Embodiments herein disclose a method operated by a video-see-through (VST) device. In an embodiment, the method may comprise: receiving at least one user gesture of a user for selecting a spatial region of interest (ROI) within a field of view of the user; recognizing the spatial ROI and at least one object located within the spatial ROI; generating at least one virtual bounding region enclosing the at least one recognized object located within the selected spatial ROI; determining at least one associated modality for enabling an interaction with the at least one object located within the at least one virtual bounding region; and generating at least one prompt corresponding to at least one associated modality for interaction with the at least one object. The prompt is generated based on a relative position of a hand of the user and the spatial ROI.

In an embodiment, the recognizing of the spatial ROI and the at least one object located within the selected spatial ROI may comprise: determining a mode of vision of the user viewing through the VST device, as an Augmented Reality (AR) mode; identifying the at least one user gesture and the at least one object located in a physical environment of vision as viewed by the user by analyzing the physical environment of vision; and recognizing the spatial ROI and the at least one object located within the selected spatial ROI.

In an embodiment, the recognizing of the spatial ROI and the at least one object selected by the user located within the spatial ROI may comprise: identifying the at least one user gesture by analyzing a virtual environment of vision as viewed by the user within the VST device, when a mode of vision of the user is an immersive mode; recognizing the spatial ROI as selected by the user; and fitting the at least one object of the virtual environment of vision within the spatial ROI.

In an embodiment, the generating of the at least one virtual bounding region for the spatial ROI may comprise: scaling a size of the boundary of the spatial ROI based on relative positions of hands of the user changed by the at least one user gesture.

In an embodiment, the recognizing of the spatial ROI and the at least one object located within the spatial ROI may comprise: detecting, by a head gaze tracker of the VST device, head orientation of the user; and detecting, by an eye gaze tracker of the VST device, eye gaze of the user. In an embodiment, the generating of the at least one virtual bounding region for the spatial ROI may comprise scaling a size of the boundary of the spatial ROI based on at least one of the at least one gesture, the head orientation of the user, or the eye gaze of the user.

In an embodiment, the generating of the at least one virtual bounding region for the spatial ROI may comprise: generating an initial ROI boundary based on a plurality of initial ROI marking points, wherein the initial ROI boundary is at least one of a two-dimensional (2D) and a three-dimensional (3D) initial ROI boundary; and transforming spatially the initial ROI boundary based on a visual analysis of a scene as viewed by the user through the VST device and a plurality of transferal ROI marking points as received from the at least one user gesture.

In an embodiment, the determining of the at least one associated modality for enabling an interaction with the at least one object located within the spatial ROI may comprise: determining at least one likely input command for user interaction with the at least one object located within the spatial ROI, based on the at least one object and at least one of at least a textual element, at least an audio element and at least a visual element located with the at least one object within the spatial ROI; and determining a most likely associated modality by which the user specifies the at least one likely input command.

In an embodiment, the recognizing of the spatial ROI and the at least one object located within the spatial ROI may comprise: detecting a hold of the at least one user gesture for a time interval; and recognizing the at least one object in the field of view over the time interval.

In an embodiment, the generating of the at least one prompt corresponding to the at least one associated modality may comprise: generating at least one of: at least one voice prompt, based on the at least one associated modality, for interacting with the at least one object; and at least one visual prompt based on the at least one associated modality, wherein the at least one visual prompt is generated by tracking position of the user and performing a hand reach assessment of the user; adjusting the at least one prompt based on change in the at least one user gesture and change in the at least one object as selected; and rendering at least one of the at least one voice prompt and the at least one visual prompt. In an embodiment, the method may further comprise displaying of the rendered at least one of the at least one voice prompt and the at least one visual prompt onto a display of the VST device.

Embodiments herein disclose a method operated by in a video-see-through (VST) device for enabling gesture based object interactions. In an embodiment, the method may comprise: receiving a user gesture indicative of a selection of a region of interest within a field of view during at least one of an immersive mode and an Augmented reality (AR) mode of the VST device; recognizing a three dimensional space and one or more objects including an application, an appliance, a real object and a virtual object within the three dimensional space of the VST device; scaling a boundary of the region of interest relative to the three dimensional space and the gesture to generate the region of interest in the field of view of the user; determining one or more objects in the region of interest and an associated modality for interaction with each object; generating a prompt associated with the at least one associated modality for interaction with each object; and providing the prompt for a user interaction within the field of view of the user based a relative position of a user hand and the region of interest.

Embodiments herein disclose a video-see-through (VST) device. In an embodiment, the VST device may comprise: an user input interface configured to receive gesture input from a user; at least one memory storing one or more instructions; and at least one processor operatively connected to the at least one memory. In an embodiment, the at least one processor may be configured to execute the one or more instructions to cause the VST device to: receive, through the user input interface, at least one user gesture of the user for selecting a spatial region of interest (ROI) within a field of view of the user, recognize the spatial ROI and at least one object located within the spatial ROI, generate at least one virtual bounding region enclosing the at least one recognized object located within the selected spatial ROI, determine at least one associated modality for enabling an interaction with the at least one object located within the at least one virtual bounding region, and generate at least one prompt corresponding to the at least one associated modality for interaction with the at least one object, based on a relative position of a hand of the user and the spatial ROI.

In an embodiment, the at least one processor may be further configured to execute the one or more instructions to cause the VST device to: determine a mode of vision of the user viewing through the VST device, as an Augmented Reality (AR) mode, identify the at least one user gesture and the at least one object located in a physical environment of vision as viewed by the user by analyzing the physical environment of vision, and recognize the spatial ROI and the at least one object located within the selected spatial ROI.

In an embodiment, the at least one processor may be further configured to execute the one or more instructions to cause the VST device to: identify the at least one user gesture by analyzing a virtual environment of vision as viewed by the user within the VST device, when a mode of vision of the user is an immersive mode, recognize the spatial ROI as selected by the user, and fit the at least one object of the virtual environment of vision within the spatial ROI.

In an embodiment, the at least one processor may be further configured to execute the one or more instructions to cause the VST device to: scale a size of the boundary of the spatial ROI based on relative positions of hands of the user by change of the at least one user gesture.

In an embodiment, the VST device may further comprise: a head gaze tracker configured to detect head orientation of the user; and an eye gaze tracker configured to detect eye gaze of the user. In an embodiment, the at least one processor is further configured to execute the one or more instructions to cause the VST device to: scale a size of the boundary of the spatial ROI based on at least one of the at least one gesture, the head orientation of the user detected by the head gaze tracker, or the eye gaze of the user detected by the eye gaze tracker.

In an embodiment, the at least one processor may be further configured to execute the one or more instructions to cause the VST device to: generate an initial ROI boundary based on a plurality of initial ROI marking points, wherein the initial ROI boundary may be at least one of a two-dimensional (2D) and a three-dimensional (3D) initial ROI boundary, and transform spatially the initial ROI boundary based on a visual analysis of a scene as viewed by the user through the VST device and a plurality of transferal ROI marking points as received from the at least one user gesture.

In an embodiment, the at least one processor may be further configured to execute the one or more instructions to cause the VST device to: determine at least one likely input command for user interaction with the at least one object located within the spatial ROI, based on the at least one object and at least one of at least a textual element, at least an audio element and at least a visual element located with the at least one object within the spatial ROI, and determine a most likely associated modality by which the user specifies the at least one likely input command.

In an embodiment, the at least one processor may be further configured to execute the one or more instructions to cause the VST device to: detect a hold of the at least one user gesture for a time interval, and recognize the at least one object in the field of view over the time interval.

In an embodiment, the at least one processor may be further configured to execute the one or more instructions to cause the VST device to: generate at least one of: at least one voice prompt, based on the at least one associated modality, for interacting with the at least one object, and at least one visual prompt based on the at least one associated modality, wherein the at least one visual prompt is generated by tracking position of the user and performing a hand reach assessment of the user, adjust the at least one prompt based on change in the at least one user gesture and change in the at least one object as selected, and render at least one of the at least one voice prompt and the at least one visual prompt.

In an embodiment, the VST device may further comprise a display, and the at least one processor may be further configured to execute the one or more instructions to cause the VST device to: control the display to display the rendered at least one of the at least one voice prompt and the at least one visual prompt.

In an embodiment, the ROI processor 108 may include a visual AI module, a textual AI module, and an audio AI module. The visual AI module may be used to understand visual elements in the marked ROI; e.g., object recognition, face recognition etc. The textual AI module may be used to recognize textual elements in the ROI; e.g., phone number. The audio AI module may be used to recognize audio present in the ROI; e.g., speech/music etc.

The embodiments disclosed herein may be implemented through at least one software program running on at least one hardware device and performing network management functions to control the network elements. The network elements shown in FIGS. 1 and 2 include blocks which may be at least one of a hardware device, or a combination of hardware device and software module.

The embodiment disclosed herein describes method(s) and system(s) for interacting with at least one real world object by facilitating spatial-temporal marking using a VST device. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., Very high speed integrated circuit Hardware Description Language (VHDL) another programming language, or implemented by one or more VHDL or several software modules being executed on at least one hardware device. The hardware device may be any kind of portable device that may be programmed. The device may also include means which could be e.g., hardware means like e.g., an ASIC, or a combination of hardware and software means, e.g., an ASIC and an FPGA, or at least one microprocessor and at least one memory with software modules located therein. The method embodiments described herein could be implemented partly in hardware and partly in software. Alternatively, the disclosure may be implemented on different hardware devices, e.g., using a plurality of CPUs.

The foregoing description of the specific embodiments will so fully reveal the general nature of the embodiments herein that others may, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. The phraseology or terminology employed herein is for the purpose of description and not of limitation. Therefore, while the embodiments herein have been described in terms of embodiments and examples, those skilled in the art will recognize that the embodiments and examples disclosed herein may be practiced with modification within the scope of the embodiments as described herein.

What is claimed is:

1. A method operated by a video-see-through (VST) device, the method comprising:
receiving at least one user gesture of a user for selecting a spatial region of interest (ROI) within a field of view of the user;
recognizing the spatial ROI and at least one object located within the spatial ROI;
generating at least one virtual bounding region enclosing the at least one recognized object located within the selected spatial ROI;
determining at least one associated modality for enabling an interaction with the at least one object located within the at least one virtual bounding region; and
generating at least one prompt corresponding to at least one associated modality for interaction with the at least one object
wherein the prompt is generated based on a relative position of a hand of the user and the spatial ROI.

2. The method of claim 1, wherein the generating of the at least one virtual bounding region for the spatial ROI comprises:
scaling a size of the boundary of the spatial ROI based on relative positions of hands of the user changed by the at least one user gesture.

3. The method of claim 1, wherein the recognizing of the spatial ROI and the at least one object located within the spatial ROI, comprises:
detecting, by a head gaze tracker of the VST device, head orientation of the user; and
detecting, by an eye gaze tracker of the VST device, eye gaze of the user,
wherein the generating of the at least one virtual bounding region for the spatial ROI, comprises:
scaling a size of the boundary of the spatial ROI based on at least one of the at least one gesture, the head orientation of the user, or the eye gaze of the user.

4. The method of claim 1, wherein the generating of the at least one virtual bounding region for the spatial ROI, comprises:
generating an initial ROI boundary based on a plurality of initial ROI marking points, wherein the initial ROI boundary is at least one of a two-dimensional (2D) and a three-dimensional (3D) initial ROI boundary; and
transforming spatially the initial ROI boundary based on a visual analysis of a scene as viewed by the user through the VST device and a plurality of transferal ROI marking points as received from the at least one user gesture.

5. The method of claim 1, wherein the determining of the at least one associated modality for enabling an interaction with the at least one object located within the spatial ROI, comprises:
determining at least one likely input command for user interaction with the at least one object located within the spatial ROI, based on the at least one object and at least one of at least a textual element, at least an audio element and at least a visual element located with the at least one object within the spatial ROI; and
determining a most likely associated modality by which the user specifies the at least one likely input command.

6. The method of claim 1, wherein the recognizing of the spatial ROI and the at least one object located within the spatial ROI comprises:
detecting a hold of the at least one user gesture for a time interval; and
recognizing the at least one object in the field of view over the time interval.

7. The method of claim 1, wherein the generating of the at least one prompt corresponding to the at least one associated modality, comprises:
generating at least one of:
at least one voice prompt, based on the at least one associated modality, for interacting with the at least one object; and
at least one visual prompt based on the at least one associated modality, wherein the at least one visual prompt is generated by tracking position of the user and performing a hand reach assessment of the user;
adjusting the at least one prompt based on change in the at least one user gesture and change in the at least one object as selected; and
rendering at least one of the at least one voice prompt and the at least one visual prompt, and
wherein the method further comprises:
displaying the rendered at least one of the at least one voice prompt and the at least one visual prompt onto a display of the VST device.

8. A video-see-through (VST) device comprising:
an user input interface configured to receive gesture input from a user;
at least one memory storing one or more instructions; and
at least one processor operatively connected to the at least one memory and configured to execute the one or more instructions to cause the VST device to:
receive, through the user input interface, at least one user gesture of the user for selecting a spatial region of interest (ROI) within a field of view of the user,
recognize the spatial ROI and at least one object located within the spatial ROI;
generate at least one virtual bounding region enclosing the at least one recognized object located within the selected spatial ROI,
determine at least one associated modality for enabling an interaction with the at least one object located within the at least one virtual bounding region, and
generate at least one prompt corresponding to the at least one associated modality for interaction with the at least one object, based on a relative position of a hand of the user and the spatial ROI.

9. The VST device of claim 8, wherein the at least one processor is further configured to execute the one or more instructions to cause the VST device to:
scale a size of the boundary of the spatial ROI based on relative positions of hands of the user by change of the at least one user gesture.

10. The VST device of claim 8, further comprising:
a head gaze tracker configured to detect head orientation of the user; and
an eye gaze tracker configured to detect eye gaze of the user,
wherein the at least one processor is further configured to execute the one or more instructions to cause the VST device to:
scale a size of the boundary of the spatial ROI based on at least one of the at least one gesture, the head orientation of the user detected by the head gaze tracker, or the eye gaze of the user detected by the eye gaze tracker.

11. The VST device of claim 8, wherein the at least one processor is further configured to execute the one or more instructions to cause the VST device to:
generate an initial ROI boundary based on a plurality of initial ROI marking points, wherein the initial ROI boundary may be at least one of a two-dimensional (2D) and a three-dimensional (3D) initial ROI boundary, and
transform spatially the initial ROI boundary based on a visual analysis of a scene as viewed by the user through the VST device and a plurality of transferal ROI marking points as received from the at least one user gesture.

12. The VST device of claim 8, wherein the at least one processor is further configured to execute the one or more instructions to cause the VST device to:
determine at least one likely input command for user interaction with the at least one object located within the spatial ROI, based on the at least one object and at least one of at least a textual element, at least an audio element and at least a visual element located with the at least one object within the spatial ROI, and
determine a most likely associated modality by which the user specifies the at least one likely input command.

13. The VST device of claim 8, wherein the at least one processor is further configured to execute the one or more instructions to cause the VST device to:
detect a hold of the at least one user gesture for a time interval, and
recognize the at least one object in the field of view over the time interval.

14. The VST device of claim 8, wherein the at least one processor is further configured to execute the one or more instructions to cause the VST device to:
generate at least one of:
at least one voice prompt, based on the at least one associated modality, for interacting with the at least one object, and
at least one visual prompt based on the at least one associated modality, wherein the at least one visual prompt is generated by tracking position of the user and performing a hand reach assessment of the user,
adjust the at least one prompt based on change in the at least one user gesture and change in the at least one object as selected, and
render at least one of the at least one voice prompt and the at least one visual prompt.

15. The VST device of claim 14, further comprises:
A display; and
wherein the at least one processor is further configured to execute the one or more instructions to cause the VST device to:
control the display to display the rendered at least one of the at least one voice prompt and the at least one visual prompt.
